(19) United States
(12) Patent Application Publication
(10) Pub. No.: US 2007/0177263 A1
(43) Pub. Date: Aug. 2, 2007

(54) Back projection-type screen and back projection-type projection device

(75) Inventor: Youji Ono, Niigata (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KURARAY CO. LTD, OKAYAMA (JP)

(21) Appl. No.: 11/658,145

(22) PCT Filed: Jul. 21, 2005
(86) PCT No.: PCT/JP05/13361

§ 371 Date: Jan. 23, 2007

(30) Foreign Application Priority Data
Jul. 23, 2004 (JP) 2004-216086

(51) Int. Cl. G03B 21/60

(52) U.S. Cl. 359/457

(57) ABSTRACT

A rear projection-type screen and a rear projection-type projection device, in which contrast is enhanced, unevenness of an external light absorption layer is reduced, moiré trouble is suppressed, damage due to contact between sheets is suppressed, and the entire projection device can be reduced in size and weight. The rear projection-type screen is the so-called oblique projection system where the optical center of a Fresnel lens sheet 7 is located at a position outside a display screen area, above or below the screen. The lens array 12 of a lenticular lens sheet 1 is arranged substantially in the vertical direction. Moiré can be reduced by setting the pitch of Fresnel lens and the lens pitch of the lenticular lens sheet within a predetermined range.

### TECHNICAL FIELD

The present invention relates to a rear projection-type screen and a rear projection-type projection device using a rear projection-type screen.

### BACKGROUND ART

A rear projection-type screen that is used for a rear projection-type projection device or the like is typically made of two lens sheets which are laid out next to one another. A Fresnel lens sheet to narrow the image light from a rear projection-type projector to a certain range of angle is placed on the light source side, and a diffusion sheet to spread the image light transmitted through the Fresnel lens sheet to encompass an appropriate range of angle is placed on the observer's side. A lenticular lens sheet or an optical sheet as disclosed in Patent Document 1 is generally used as the diffusion sheet. A lenticular lens sheet for a rear projection-type screen as referred to in this specification includes a diffusion sheet which is provided with stripe or matrix optical units as shown in Patent Document 1, not only those provided with a lens array, unless it produces a contradiction.

Particularly, a high-definition and high-quality liquid crystal rear projection-type liquid crystal projection television requires a lens sheet with a fine pitch of 0.3 mm or less. The configuration of such a lens sheet is described in Patent Document 2, for example. FIG. 22 shows the configuration of the lens sheet disclosed in Patent Document 2.

FIG. 22 shows an example of a lenticular lens sheet. In this example, the lenticular lens sheet 1 includes a transparent base 3 and a lens portion 2. On the light exit surface of the lenticular lens sheet 1, an external light absorption layer 4 is placed in a non-light-focusing portion or a non-light-transmission portion of the lenticular lens. The presence of the external light absorption layer 4 reduces the amount of external light which is incident on the light exit surface of the lenticular lens sheet 1 on the observer's side and reflected by the lenticular lens sheet 1 back to the observer's side, thereby improving the image contrast.

Further, a transparent resin film 6 is placed beside the lenticular lens sheet 1 with a diffusion layer 5 interposed therebetween. The transparent resin film 6 is described in Patent Document 3 and 4, for example. The transparent resin film 6 is placed in order to protect the lenticular lens sheet, to obtain profiles with a surface gloss similar to that of a typical cathode ray tube television, and so on.

In addition, a Fresnel lens sheet 7 is typically placed on the light incident surface side of the lenticular lens sheet 1 as shown in FIG. 23. The Fresnel lens sheet 1 is normally a sheet where a Fresnel lens composed of a fine-pitch equidistant concentric lens is formed on the light exit surface.

In the lens sheet having such a configuration, the horizontal viewing angle is determined by the diffusion through an incident lens, and the vertical viewing angle is determined only by the diffusion layer 5 (cf. FIG. 22). Thus, the reflection loss of incident light occurs due to the diffusion material which is used to obtain a required viewing angle, which theoretically poses a limit to the achievement of high brightness screen and causes image blur. Moreover, because the diffusion layer 5 covers the external light absorption layer 4, the external light absorption efficiency decreases to degrade image contrast. Furthermore, the external light absorption layer 4 can only have a shape of parallel stripes theoretically, which poses a limit to obtained black area ratio.

On the other hand, there is proposed a 3D lens array sheet for a projection-type screen. In the 3D lens array sheet, 3D convex lenses are placed on the light incident surface and a lattice-like light shielding pattern is formed on the light exit surface at the position corresponding to the non-light-focusing portion of each lens, and a transparent base or a base with a diffusion layer is formed on the pattern.

This technique allows the light shielding pattern to be shaped like a lattice and eliminates or minimizes the diffusion layer, thereby significantly improving image contrast. However, the production of a fine 3D lens array sheet requires a highly accurate and large-scale die which is extremely difficult to produce.

To address these problems, a technique of providing lenticular lenses on both of the light incident surface and the light exit surface of a lenticular lens sheet in such a way that those lenses are arranged perpendicular to each other is proposed (for example, see Patent Document 5). In such a configuration as well, an external light absorption layer as a light shielding pattern is placed to improve contrast. In the related art, the external light absorption layer is formed on a different sheet from the lenticular lens sheet.

If the external light absorption layer is formed on a different sheet from the lenticular lens sheet, the relative position of the sheets along the creepage can be misaligned, and it is thereby extremely difficult to accurately place the external light absorption layer at the non-light-transmission portion of the lenticular lens. Further, the distance between the sheets can change due to temperature or humidity change to cause displacement of the lens focus position and thereby reduce the area of the external light absorption layer, which hampers the improvement of contrast or causes surface unevenness of the external light absorption layer.

Further, an increase in the number of lens sheets complicates the work of securing them to a television set frame. Furthermore, if the sheets are transported with being secured to the television set frame, the sheets can be damaged due to the contact against each other. It is therefore not preferable to increase the number of lens sheets.

In addition, in order to prevent moiré which can occur in a certain pitch ratio of a lenticular lens and a Fresnel lens, it is necessary to set each value within a specific range to provide high-quality images. Particularly, if the lenticular lens consists of vertical stripe and horizontal stripe patterns, a lattice pattern along the screen diagonal direction is formed by the matrix-like lenticular lens as shown in FIG. 25. In the lattice pattern, lines 103 where the points of intersection of vertical and horizontal stripes 101 and 102 are sequentially aligned exist. A pitch P of this line interferes with a pitch Pf of the Fresnel lens to cause moiré to occur. This remains as a problem to be solved in order to provide high-quality images.

FIG. 26 illustrates a configuration example of a typical rear projection-type projection device. This configuration includes an optical system shown in FIG. 23, in which a reflective mirror 52 is placed to bend an image beam path for reducing the length or weight of the entire device. Further size and weight reduction, however, is demanded.

[Patent Document 1] Japanese Unexamined Patent Application Publication No. 2000-131768

[Patent Document 2] Japanese Unexamined Patent Application Publication No. 9-120101

[Patent Document 3] Japanese Unexamined Patent Application Publication No. 8-22077

[Patent Document 4] Japanese Unexamined Patent Application Publication No. 7-307912

[Patent Document 5] Japanese Unexamined Patent Application Publication No. 50-10134

### DISCLOSURE OF THE INVENTION

### Problems to be Solved by the Invention

The present invention has been accomplished to solve the above problems and an object of the present invention is thus to provide a rear projection-type screen and a rear projection-type projection device, in which contrast is enhanced, unevenness of an external light absorption layer is reduced, moiré trouble is suppressed, damage due to contact between sheets is suppressed, and the entire projection device can be reduced in size and weight.

### Means for Solving the Problems

To these ends, there is provided a rear projection-type screen including a Fresnel lens sheet for narrowing light emitted from a rear projection-type projector to a certain range of angle; and a light diffusion sheet including a plurality of at least substantially vertically and linearly successive optical patterns arranged in substantially horizontal direction, wherein an optical center of the Fresnel lens sheet is located outside a display screen area, above or below the screen, and any one of following equations (1) to (3) is satisfied:

$$\begin{matrix}\frac{P 1}{Pf} = i + 0.0 \sim 0.35 or \frac{P 1}{Pf} = \frac{1}{i + 0.0 \sim 0.35} & ( 1 ) \\ \frac{P 1}{Pf} = i + 0.45 \sim 0.55 or \frac{P 1}{Pf} = \frac{1}{i + 0.45 \sim 0.55} & ( 2 ) \\ \frac{P 1}{Pf} = i + 0.65 \sim 1.0 or \frac{P 1}{Pf} = \frac{1}{i + 0.65 \sim 1.0} & ( 3 )\end{matrix}$$

where i represents a natural number of 12 or less, Pf(mm) represents a pitch of the Fresnel lens, and P1(mm) represents a pitch of the optical patterns of the light diffusion sheet.

When the substantially vertically and linearly successive optical patterns constitute a first optical pattern array, it is preferred to further include a second optical pattern array substantially perpendicular to the first optical pattern array, on a light exit side of the first optical pattern array.

Particularly, the light diffusion sheet preferably includes the first optical pattern array having a cylindrical lens shape placed on a light incident surface of the light diffusion sheet, the second optical pattern array serving as an interface between a light incident side and a light exit side that are formed of light transmissive materials having different refractive indexes from each other, and a self-aligned external light absorbing layer placed on at least part of a non-transmission portion of light transmitted through the first optical pattern array and the second optical pattern array, such that the light transmissive materials are filled between the light incident surface of the light diffusion sheet and the self-aligned external light absorption layer.

It is also preferred that the Fresnel lens sheet and the light diffusion sheet satisfy either one of following equations (4) or (5) and further satisfy a following equation (6):

$$\begin{matrix}\frac{P 2}{Pf} = i + 0.35 \sim 0.45 or \frac{P 2}{Pf} = \frac{1}{i + 0.35 \sim 0.45} & ( 4 ) \\ \frac{P 2}{Pf} = i + 0.55 \sim 0.65 or \frac{P 2}{Pf} = \frac{1}{i + 0.55 \sim 0.65} & ( 5 ) \\ PM = \frac{1}{\vert \frac{1}{P} - \frac{1}{Pf} \vert} \leq 3 ( mm ) & ( 6 )\end{matrix}$$

where i represents a natural number of 12 or smaller, a lens pitch of the first lenticular lens is P1 (mm), a lens pitch of the second lenticular lens is P2 (mm), a pitch of a lattice pattern by P1 and P2 along a screen diagonal direction is P (mm) that is calculated from a following equation (7), a pitch of a moiré pattern due to P and Pf is PM (mm), and n and m represent natural numbers of 4 or smaller:

$$P = \frac{1}{\sqrt{\frac{1}{{n}^{2} P {1}^{2}} + \frac{1}{{m}^{2} P {2}^{2}}}} \qquad ( 7 )$$

There is also provided a rear projection-type screen including a Fresnel lens sheet for narrowing light emitted from a rear projection-type projector to a certain range of angle; and a microlens array sheet including a microlens array placed on a light incident surface to diffuse light in substantially horizontal and vertical directions, and a self-aligned external light absorbing layer placed on at least part of a non-transmission portion of light transmitted through the microlens array, wherein an optical center of the Fresnel lens sheet is located outside a display screen area, above or below the screen, the Fresnel lens sheet and the microlens array sheet satisfy any one of following equations (1*) to (3*), and the Fresnel lens sheet and the microlens array sheet satisfy either one of following equations (4*) or (5*) and further satisfy a following equation (6*):

$$\begin{matrix}\frac{P {1}^{★}}{Pf} = i + 0.0 \sim 0.35 or \frac{P {1}^{★}}{Pf} = \frac{1}{i + 0.0 \sim 0.35} & ( {1}^{★} ) \\ \frac{P {1}^{★}}{Pf} = i + 0.45 \sim 0.55 or \frac{P {1}^{★}}{Pf} = \frac{1}{i + 0.45 \sim 0.55} & ( {2}^{★} ) \\ \frac{P {1}^{★}}{Pf} = i + 0.65 \sim 1.0 or \frac{P {1}^{★}}{Pf} = \frac{1}{i + 0.65 \sim 1.0} & ( {3}^{★} )\end{matrix}$$

where i represents a natural number of 12 or smaller, Pf(mm) represents a pitch of the Fresnel lens, and P1*(mm) represents an effective pitch of the microlens array in substantially horizontal direction,

$$\begin{matrix}\frac{P {2}^{★}}{Pf} = i + 0.35 \sim 0.45 or \frac{P {2}^{★}}{Pf} = \frac{1}{i + 0.35 \sim 0.45} & ( {4}^{★} ) \\ \frac{P {2}^{★}}{Pf} = i + 0.55 \sim 0.65 or \frac{P {2}^{★}}{Pf} = \frac{1}{i + 0.55 \sim 0.65} & ( {5}^{★} ) \\ {PM}^{★} = \frac{1}{\vert \frac{1}{{P}^{★}} - \frac{1}{Pf} \vert} \leq 3 ( mm ) & ( {6}^{★} )\end{matrix}$$

where i represents a natural number of 12 or smaller, an effective pitch of a microlens array in substantially vertical direction is P2*(mm), a pitch of a lattice by P1* and P2* in a screen diagonal direction is P*(mm) that is calculated from a following equation (7*), a pitch of a moiré pattern due to P* and Pf is PM*(mm), and n and m represent natural numbers or 4 or smaller,

$${P}^{★} = \frac{1}{\sqrt{\frac{1}{{n}^{2} P {1}^{★}} + \frac{1}{{m}^{2} P {2}^{{★}^{2}}}}} . \qquad ( {7}^{★} )$$

In a preferred embodiment, the Fresnel lens sheet has a circular-arc prism array on the light incident surface, at least part of the prism array having a total reflection plane such that at least part of light incident on the prism array is totally reflected by the total reflection plane and exits through a light exit plane.

The second optical pattern array of the light diffusion sheet may be composed of a plurality of cylindrical lenses that are convex toward the light incident side, and a light transmissive material on a light exit side from an interface of the second optical pattern array may have a higher refractive index than a light transmissive material on a light incident side.

Further, the second optical pattern array of the light diffusion sheet may be composed of a plurality of cylindrical lenses that are concave toward the light incident side, and a light transmissive material on a light exit side from an interface of the second optical pattern array may have a lower refractive index than a light transmissive material on a light incident side.

There is also provided a rear projection-type projection device including the above-described rear projection-type screen.

### ADVANTAGES OF THE INVENTION

The present invention can provide a rear projection-type screen and a rear projection-type projection device, in which contrast is enhanced, unevenness of an external light absorption layer is reduced, moiré trouble is suppressed, damage due to contact between sheets is suppressed, and the entire projection device can be reduced in size and weight.

### BRIEF DESCRIPTION OF THE DRAWINGS

FIG. 1 is a perspective view showing a part of a rear projection-type screen configuration according to a first embodiment of the present invention;

FIG. 2 is a schematic perspective view of a Fresnel lens sheet according to the first embodiment of the present invention;

FIG. 3 is a schematic view showing an optical system of a rear projection-type projection device according to the first embodiment of the present invention;

FIG. 4 is a perspective view showing a part of a lenticular lens sheet configuration according to a second embodiment of the present invention;

FIG. 5A is a top sectional view of a lenticular lens sheet configuration according to the second embodiment of the present invention;

FIG. 5B is a cross sectional view of a lenticular lens sheet configuration according to the second embodiment of the present invention;

FIG. 6 is a perspective view showing a part of a lenticular lens sheet configuration according to a third embodiment of the present invention;

FIG. 7 is a perspective view showing a part of a lenticular lens sheet configuration according to a fourth embodiment of the present invention;

FIG. 8A is a top sectional view of a lenticular lens sheet configuration according to the fourth embodiment of the present invention;

FIG. 8B is a cross sectional view of a lenticular lens sheet configuration according to the fourth embodiment of the present invention;

FIG. 9 is a perspective view showing a part of a lenticular lens sheet configuration according to a fifth embodiment of the present invention;

FIG. 10 is a perspective view showing a part of a lenticular lens sheet configuration according to a sixth embodiment of the present invention;

FIG. 11 is a perspective view showing a part of a lenticular lens sheet configuration according to a seventh embodiment of the present invention;

FIG. 12 is a perspective view showing a part of a lenticular lens sheet configuration according to an eighth embodiment of the present invention;

FIG. 13 is a perspective view showing a part of a lenticular lens sheet configuration according to a ninth embodiment of the present invention;

FIG. 14 is a perspective view showing a part of a lenticular lens sheet configuration according to a tenth embodiment of the present invention;

FIG. 15 is a view showing a prism array part of a Fresnel lens sheet according to an eleventh embodiment of the present invention;

FIG. 16 is a view showing a prism array part of a Fresnel lens sheet according to a twelfth embodiment of the present invention;

FIG. 17 is a view showing a prism array part of a Fresnel lens sheet according to a thirteenth embodiment of the present invention;

FIG. 18 is a perspective view showing a part of a rear projection-type screen configuration according to a fourteenth embodiment of the present invention;

FIG. 19A is a view to describe an example of an effective pitch according to the present invention;

FIG. 19B is a view to describe another example of an effective pitch according to the present invention;

FIG. 19C is a view to describe another example of an effective pitch according to the present invention;

FIG. 20 is a table showing a combination of refractive indexes of lens unit elements and various measurement figures of a lens shape related to an example;

FIG. 21A is a top sectional view of a lens unit element in an example;

FIG. 21B is a cross sectional view of a lens unit element in an example;

FIG. 22 is a cross sectional view showing a lenticular lens sheet configuration according to a related art;

FIG. 23 is a schematic view showing an optical system of a typical rear projection-type projection device according to a related art;

FIG. 24 is a schematic perspective view of a typical Fresnel lens sheet according to a related art;

FIG. 25 is a view showing that a lattice pattern along a screen diagonal direction is formed by vertical and horizontal lenticular lens arrays according to a related art; and

FIG. 26 is a view showing the configuration of a typical rear projection-type projection device according to a related art.

### DESCRIPTION OF REFERENCE NUMERALS

| | |
|---|---|
| 1 | LENTICULAR LENS SHEET |
| 2 | LENS PORTION |
| 3 | TRANSPARENT BASE |
| 4 | EXTERNAL LIGHT ABSORPTION LAYER |
| 5 | DIFFUSION LAYER |
| 6 | TRANSPARENT RESIN FILM |
| 7 | FRESNEL LENS SHEET |
| 10, 11 | LENTICULAR LENS SHEET |
| 12 | FIRST LENS ARRAY |
| 13 | SECOND LENS ARRAY |
| 14 | FIRST LENS LAYER |
| 15 | SECOND LENS LAYER |
| 16 | PACKED LAYER |
| 17 | SELF-ALIGNED EXTERNAL LIGHT |
| | ABSORPTION LAYER |
| 19 | FRONT PANEL |
| 20 | FUNCTIONAL FILM |
| 21 | TRANSPARENT BASE |
| 22, 24, 25 | PACKED LAYER |
| 23 | TRANSPARENT SHEET |
| 52 | REFLECTIVE MIRROR |
| 61 | REFLECTIVE SURFACE |
| 62, 63 | INCIDENT PLANE |
| 64 | RISE SURFACE |
| 100 | INCIDENT LIGHT |
| 101 | HORIZONTAL LATTICE LINES |
| 102 | IMAGE LIGHT |
| 103 | OBLIQUE LATTICE LINES |

### BEST MODES FOR CARRYING OUT THE INVENTION

Embodiments of the present invention are described hereinafter with reference to the drawings.

### First Embodiment

FIG. 1 is a perspective view showing a partial structure of a rear projection-type screen according to a first embodiment of the present invention. The rear projection-type screen 110 includes a lenticular lens sheet 111, a Fresnel lens sheet 112, and a front panel 113. The rear projection-type screen 110 is made up of the Fresnel lens sheet 112, the lenticular lens sheet 111, and the front panel 113 which are arranged in this order from the top to the bottom of the figure.

The lenticular lens sheet 111 is formed of a translucent substrate, on which a plurality of lenticular lenses 121 are formed on the surface on which projected light is incident. The lenticular lenses 121 are formed on the incident side of the surface through which the projected light is output from the lenticular lens sheet 111. Specifically, the lenticular lenses 121 are a plurality of convex lens arrays which are placed on the front side (incident side) when viewed from the light incident plane side so as to focus incident projected light inside a lens medium. The lenticular lenses 121 are vertically fluted cylindrical lenses which are arranged in parallel with each other. Thus, the lenticular lenses 121 focus incident light inside a lens medium and then diffuse the light horizontally on the light exit surface.

In addition to the lenticular lenses 121, the lenticular lens sheet 111 includes a light-focusing portion 122, a non-light-focusing portion 123, and an external light absorption layer 124.

The light-focusing portion 122 may be shaped like a convex lens in order to focus the light from the lenticular lenses 121. This improves the diffusion of projected light in the horizontal direction.

The non-light-focusing portion 123 is the part other than the light-focusing portion 122. Specifically, the non-light-focusing portion 123 is the part where the light from the lenticular lenses 121 which are formed on the incident plane is not focused. The non-light-focusing portion 123 may be shaped like a raised step each having a flat top which is parallel with the lenticular lens sheet 111 and side surfaces. The external light absorption layer 124 is formed on the flat top and on the part of the side surface close to the top (upper side surface).

The external light absorption layer 124 is a raised external light absorbing portion (BS portion) which is formed of black coating or the like. The external light absorption layer 124 may be formed by roll coating, screen printing, transcription, or the like. The external light absorption layer 124 reduces the external light which enters the lenticular lens sheet 111 and is reflected on the light exit surface of the lenticular lens sheet 111 back to the observer's side. This improves image contrast.

The Fresnel lens sheet 112 includes a Fresnel lens 131. The Fresnel lens 131 is a fine-pitch, substantially equidistant concentric lens which is formed on the light exit surface. In the present invention, the optical center (not shown in FIG. 1) of the Fresnel lens sheet 112 is located outside the lenticular lens sheet 111 as described later.

The front panel 113 is a light transmissive layer which serves also as a base of the lenticular lens sheet 111. The front panel 113 may include a diffusion layer or may be coated with various functional films such as HC (hard coating), AG (anti-glare), AR (anti-reflection), and AS (anti-static) on the outermost layer of its light exit surface.

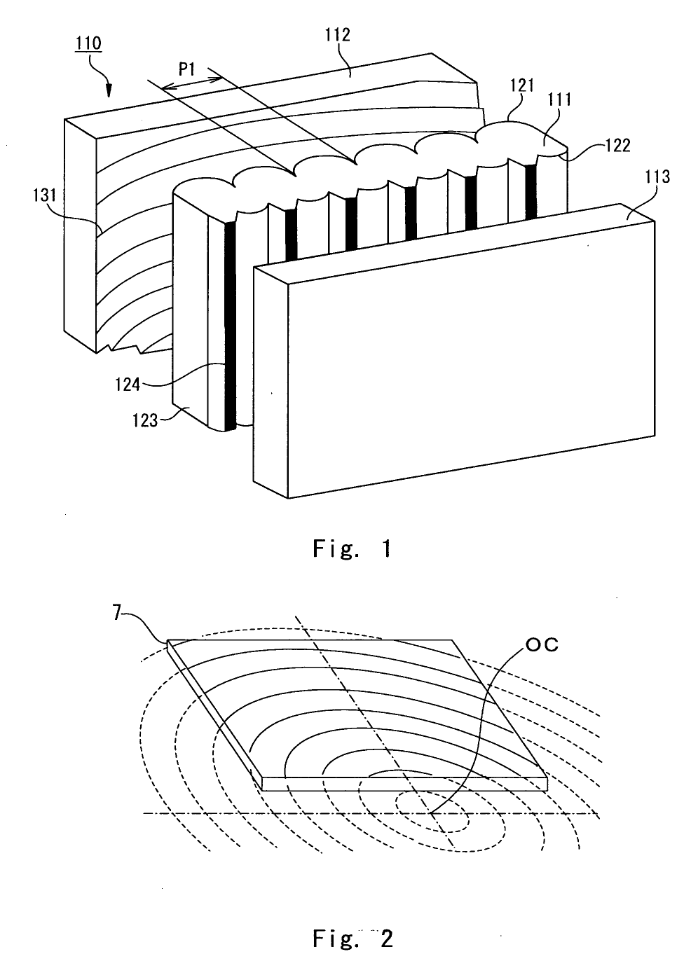

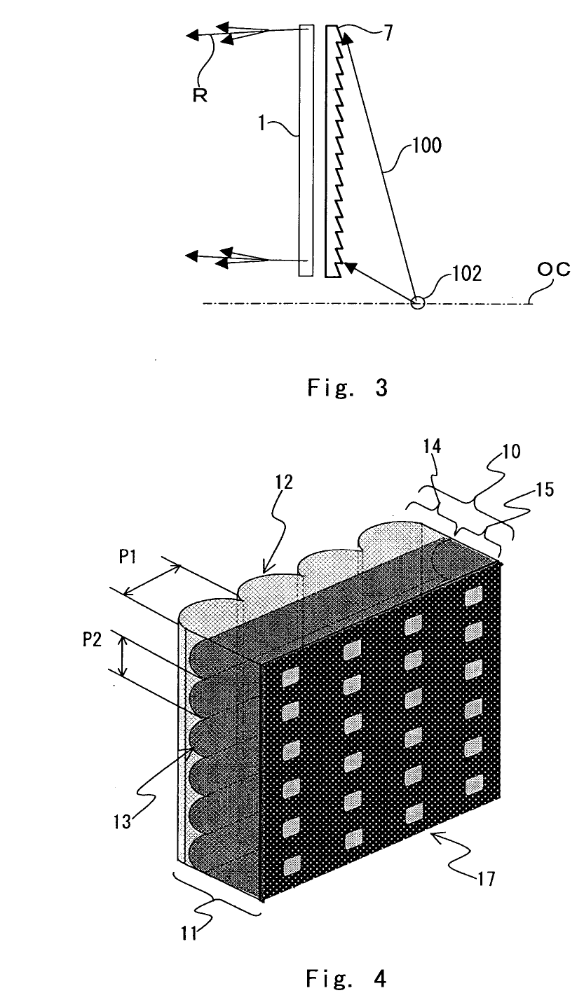

In the rear projection-type screen 110 according to the first embodiment, it is necessary to determine the combination of a lens pitch P1 of the lenticular lens 121 and a lens pitch Pf of the Fresnel lens 131 such that it does not cause a visible moiré pattern. In the present invention, the Fresnel lens sheet 112 in which the optical center OC is outside the lens sheet as shown in FIG. 2 is applied to an oblique projection display device as shown in FIG. 3. Therefore, the degree of freedom of the combination of the lens pitch P1 of the lenticular lens 121 and the lens pitch Pf of the Fresnel lens 131 for the prevention of moiré is higher than that in related arts.

The lens sheet is typically manufactured using a die. The die is generally produced by machining. The machining requires input of digitized design data into machining equipment. Most preferably, design data is an integral value. However, if an accurate value of design data contains several decimal places, a value which differs from the accurate value should be input due to the limitation to the number of digits to be input. Thus, a wide range of possible lens pitch values provides a large possibility to input an accurate value. The advantage of the present invention is significant in this aspect as well.

In the normal Fresnel lens 131 and the lenticular lens sheet 111 which includes the vertically fluted lenticular lenses 121, a curved moiré pattern is likely to occur at the center of the left and right ends of the screen. To avoid this, it is necessary to set the pitch ratio of the lenticular lenses 121 to about i+0.4 or i+0.6 (where i represents a natural number). For simplification of the description, it is assumed that the longitudinal direction of the lenticular lens 121 of the present invention is a vertical direction, and the optical center OC in FIG. 2 is located below the sheet.

According to the present invention, only a segment of a circular arc of the Fresnel lens 131 exists within the sheet and therefore there is no prism array which is parallel with the vertical direction unlike the normal Fresnel lens 131. Accordingly, it is possible to set the pitch ratio of the lens pitch P1 of the lenticular lens 121 and the lens pitch Pf of the Fresnel lens 131 not only to the known preferred range as disclosed in related arts but also to the range of i±0.35 or i+0.5±0.05 (where i represents a natural number), which cannot be set in related arts due to the occurrence of a strong moiré pattern. This effect is significant as the position of the optical center OC is away from the long side end, and preferably the optical center OC is distant from the center of the screen by 1.1 Lh or longer, more preferably 1.2 Lh or longer, and further preferably 1.3 Lh or longer, where Lh is the length of the short side.

Further, the combination of the lens pitch P1 of the lenticular lens 121 and the lens pitch Pf of the Fresnel lens 131 preferably satisfies the conditions given by any one of following equations (1) to (3). This suppresses the curved moiré pattern at the center of the left and right ends of the screen.

$$\begin{matrix}\frac{P 1}{Pf} = i + 0.0 \sim 0.35 or \frac{P 1}{Pf} = \frac{1}{i + 0.0 \sim 0.35} & ( 1 ) \\ \frac{P 1}{Pf} = i + 0.45 \sim 0.55 or \frac{P 1}{Pf} = \frac{1}{i + 0.45 \sim 0.55} & ( 2 ) \\ \frac{P 1}{Pf} = i + 0.65 \sim 1.0 or \frac{P 1}{Pf} = \frac{1}{i + 0.65 \sim 1.0} & ( 3 )\end{matrix}$$

Further, regarding the size of a pixel (PS) which is projected onto the screen and the lens pitch, each of PS/P1 and PS/Pf preferably satisfies:

j+0.35 to j+0.45, or

j+0.55 to j+0.65, or

3.3 or above

where j is 1 or 2, in order to suppress the moiré pattern due to interference among a pixel and the lens pitches P1 and Pf.

The pixel size PS varies depending on the size of the screen. In terms of productivity, it is inefficient to select an optimal pitch for each screen size before production. It is preferable to satisfy the above-described range of PS/P1 and PS/Pf at the same time in all screen sizes with a minimum number or, if possible, a single kind of pitch to prevent the occurrence of a moiré pattern. On the other hand, although further reduction of the pitches P1 and Pf is required to meet the recent demand for high definition images, it is difficult to make the further reduction of pitch in light of die cutting and moldability. Such circumstances increase the situation that the ratio of P1 and Pf should be about 2 to 3, or, the value of i in the equations (1) to (3) should be selected from a small range of about 1 to 3. Although there is no particular limitation to the value of the equations (1) to (3), the advantage of the present invention enabling a high degree of freedom of pitch selection is significant when the lens pitch P1 of the lenticular lens 121 and the lens pitch Pf of the Fresnel lens satisfy the conditions of: P1≦0.2 mm, Pf≦0.1 mm, and i≦3.

An example of the combination of pitches that satisfy the above conditions is the pitch P1 of 0.1 mm and the pitch Pf of 0.074 mm. With these pitch values, P1/Pf=1.35 in which the moiré caused by the lenticular lens array and the Fresnel lens is not significant.

### Second Embodiment

FIG. 4 is a perspective view showing the structure of a main part of a lenticular lens sheet according to a second embodiment of the present invention. In the following description regarding the lenticular lens sheet, the structure which does not include a self-aligned external light absorption layer 17 is referred to as a lenticular lens sheet A (which is denoted by the reference numeral “10”), and the structure which includes the lenticular lens sheet A and the self-aligned external light absorption layer 17 is referred to as a lenticular lens sheet B (which is denoted by the reference numeral “11”).

The lenticular lens sheet A is made up of a combination of a first lens layer 14 and a second lens layer 15 having different refractive indexes from each other which are integrated together with a second lens array 13 placed therebetween as an interface. In the second embodiment of the present invention, the refractive index of the first lens layer 14 is lower than the refractive index of the second lens layer 15.

A first lens array 12 is placed on the light incident surface of the lenticular lens sheet A, which is the incident surface of the first lens layer 14. The second lens array 13 is placed substantially perpendicularly to the first lens array 12 on the interface between the first lens layer 14 and the second lens layer 15.

The first lens array 12 is composed of a plurality of convex lenses which are placed on the front side (incident side) when viewed from the light incident plane side so as to focus incident projected light inside a lens medium. The lenses of the first lens array 12 are vertically fluted cylindrical lenses which are arranged in parallel with each other. Thus, the first lens array 12 can focus incident light inside a lens medium and then diffuse the light horizontally on the light exit surface.

The second lens array 13 is composed of a plurality of convex lenses which are placed on the front side (incident side) when viewed from the light incident plane side, just like the first lens array 12. The lenses of the second lens array 13 are horizontally fluted cylindrical lenses which are arranged in parallel with each other. The second lens array 13 is thus placed substantially perpendicular to the first lens array 12. Accordingly, because of the refractive index and the lens shape of each lens layer, the second lens array 13 can focus incident light inside a lens medium and then diffuse the light vertically on the light exit surface.

It is necessary to determine the combination of the lens pitch P1 of the first lens array 12, a lens pitch P2 of the second lens array 13 and the pitch Pf of the Fresnel lens such that it does not cause a visible moiré pattern. In the present invention, the Fresnel lens sheet in which the optical center OC is located outside the lens sheet as shown in FIG. 2 is applied to the oblique projection display device as shown in FIG. 3. Therefore, the degree of freedom of the combination between one of the first lens pitch P1 and the second lens pitch P2, and the pitch Pf for the prevention of moiré is higher than that in related arts.

The lens sheet is typically manufactured using a die. The die is generally produced by machining. The machining requires input of digitized design data into machining equipment. Most preferably, design data is an integral value. However, if an accurate value of design data contains several decimal places, a value which differs from the accurate value should be input due to the limitation to the number of digits to be input. Thus, a wide range of possible lens pitch values provides a large possibility to input an accurate value. The advantage of the present invention is significant in this aspect as well.

In the normal Fresnel lens and the lenticular lens sheet which includes the vertically fluted lens array, a curved moiré pattern is likely to occur at the center of the left and right ends of the screen. To avoid this, it is necessary to set the pitch ratio of the lenticular lenses to about i+0.4 or i+0.6 (where i represents a natural number). For simplification of the description, the longitudinal direction of the first lens array 12 of the present invention is a vertical direction, and the optical center OC in FIG. 2 is located below the sheet.

According to the present invention, only a segment of a circular arc of the Fresnel lens exists within the sheet and therefore there is no prism array which is parallel with the vertical direction unlike the normal Fresnel lens. Accordingly, it is possible to set the pitch ratio of P1 and Pf not only to the known preferred range as disclosed in related arts but also to the range of i±0.35 or i+0.5±0.05 (where i represents a natural number), which cannot be set in related arts due to the occurrence of a strong moiré pattern. This effect is significant as the position of the optical center OC is away from the long side end, and preferably the optical center OC is distant from the center of the screen by 1.1 Lh or longer, more preferably 1.2 Lh or longer, and further preferably 1.3 Lh or longer, where Lh is the length of the short side.

The combination of the lens pitch P1 of the first lens array 12, the lens pitch P2 of the second lens array 13 and the pitch Pf of the Fresnel lens preferably satisfies the conditions given by the following equations (4) or (5) and further satisfies the equation (6) in which the moiré period is 3 mm or less. This enables the suppression of the occurrence of a moiré pattern due to the interference among three sets of pitches. In the equations (6) and (7), the moiré period when the values n and m are natural numbers of 10 or smaller is preferably 3 mm or less in order to suppress higher-order moiré.

$$\begin{matrix}\frac{P 2}{Pf} = i + 0.35 \sim 0.45 or \frac{P 2}{Pf} = \frac{1}{i + 0.35 \sim 0.45} & ( 4 ) \\ \frac{P 2}{Pf} = i + 0.55 \sim 0.65 or \frac{P 2}{Pf} = \frac{1}{i + 0.55 \sim 0.65} & ( 5 ) \\ PM = \frac{1}{\vert \frac{1}{P} - \frac{1}{Pf} \vert} \leq 3 ( mm ) & ( 6 )\end{matrix}$$

where i represents a natural number of 12 or smaller, a lens pitch of the first lenticular lens is P1 (mm), a lens pitch of the second lenticular lens is P2 (mm), a pitch of a lattice pattern by P1 and P2 along the screen diagonal direction is P (mm) which is calculated from the following equation (7), a pitch of a moiré pattern due to interference between P and Pf is PM (mm), and n and m represent a natural number of 4 or smaller.

$$P = \frac{1}{\sqrt{\frac{1}{{n}^{2} P {1}^{2}} + \frac{1}{{m}^{2} P {2}^{2}}}} \qquad ( 7 )$$

It is more preferred to satisfy the conditions given by the following equations (1) or (2) and further set a lens pitch P1 of the first lens array 12 to preferably 2 to 10 times, or more preferably 3 to 5 times, the lens pitch P2 of the second lens array 13.

$$\begin{matrix}\frac{P 1}{Pf} = i + 0.0 \sim 0.35 or \frac{P 1}{Pf} = \frac{1}{i + 0.0 \sim 0.35} & ( 1 ) \\ \frac{P 1}{Pf} = i + 0.45 \sim 0.55 or \frac{P 1}{Pf} = \frac{1}{i + 0.45 \sim 0.55} & ( 2 ) \\ \frac{P 1}{Pf} = i + 0.65 \sim 1.0 or \frac{P 1}{Pf} = \frac{1}{i + 0.65 \sim 1.0} & ( 3 )\end{matrix}$$

where i represents a natural number of 12 or smaller, Pf (mm) indicates the pitch of the Fresnel lens, and P1 (mm) indicates the pitch of the lens pattern array of the light diffusion sheet.

Satisfying the above conditions allows the focus positions of the first lens array 12 and the second lens array 13 to be in close proximity to each other avoiding that the tops of the vertexes of the second lens array 13 are in contact or close to the bottoms of the recessed portions of the first lens array 12. In the second embodiment, the self-aligned external light absorption layer 17 is placed in close proximity to the focus positions of the both lenses to thereby widen the area of the self-aligned external light absorption layer 17, which further improves image contrast.

If, in the lenticular lens sheet, the lens pitch P2 of the second lens array is as fine as 0.02 mm or less, an aperture through which projected light passes is so fine as to cause dot defects in the formation of the self-aligned external light absorption layer 17 or the production of a die itself is difficult. The ratio of P1 to P2 is preferably about 10 or less.

Further, regarding the pixel size PS which is projected onto the screen and the lens pitch, each of PS/P1, PS/P2 and PS/Pf preferably satisfies:

j+0.35 to j+0.45, or

j+0.55 to j+0.65, or

3.3 or above

where j is 1 or 2, in order to suppress the moiré due to the pixel and the lens pitches.

An example of the combination of pitches that satisfy the above conditions is the pitch P1 of 0.1 mm, the pitch P2 of 0.022 mm, and the pitch Pf of 0.074 mm. With these pitch values, P1/Pf=1.35 and P2/Pf=1/3.36, in which the moiré pattern caused by the lenticular lens array and the Fresnel lens is not significant. Further, the moiré period which is calculated from the equations (6) and (7) is about 0.9 mm at maximum, which allows the moiré caused by interference among three sets of pitches to be substantially invisible.

The pixel size PS which is projected on the screen is generally about 1.0 mm, and the above-described lens pitches enables the suppression of the moiré pattern due to the pixel and the lens pitches.

Further, P1 is about 4.5 times P2, so that the production of a die is easy and the focus positions of the both lenticular lenses can be in close proximity to each other.

The second lens layer 15 may be made of an acrylic resin, polycarbonate resin, MS (methyl methacrylate-styrene copolymer) resin, polystyrene, PET (polyethylene terephthalate), or the like.

On the light incident surface of the first lens layer 14, the first lens array 12 is formed by filling a radiation curable resin, for example. The first lens layer 14 is placed to cover the second lens layer 15 with the second lens array 13 placed therebetween as an interface. The light exit surface of the second lens layer 15 is flat and substantially parallel with the principal plane of the first lens array 12. The principal plane of the first lens array 12 is a plane which is formed when connecting the positions of the first lens array 12 which project most outward toward the incident side.

The second lens array 13 which serves as an interface between the first lens layer 14 and the second lens layer 15 can be perceived also as being formed on the first lens layer 14. If it is perceived as a lens which is formed on the first lens layer 14, the lenticular lens is concave when viewed from the light exit side.

The first lens layer 14 may be formed of a radiation curable resin. The radiation curable resin may be selected from an acrylic ultraviolet curable resin, silicon ultraviolet curable resin, fluorine ultraviolet curable resin, and so on. The refractive index of the first lens layer 14 needs to be lower than that of the second lens layer 15. In the second embodiment, an acrylic ultraviolet curable resin with the refractive index of 1.49 is used for the first lens layer, and a MS resin with the refractive index of 1.58 is used for the second lens layer. A difference in refractive index between the first lens layer 14 and the second lens layer 15 is preferably 0.05 or above, and more preferably 0.1 or above.

On the light exit surface of the second lens layer 15, the self-aligned external light absorption layer 17 is formed. The self-aligned external light absorption layer 17 is placed on the non-light-focusing portions or non-light-transmission portions of the first lens array 12 and the second lens array 13. In the second embodiment, the self-aligned external light absorption layer 17 is formed in a lattice pattern. The self-aligned external light absorption layer 17 may be made of a light shielding photocurable resin.

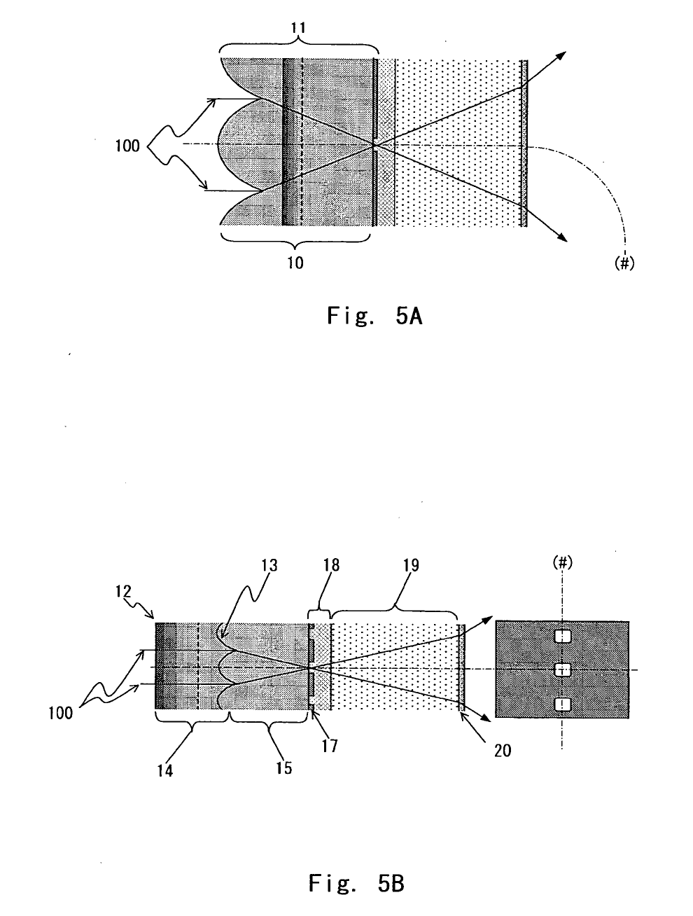

FIGS. 5A and 5B are a top sectional view and a cross sectional view, respectively, of a lenticular lens sheet which constitutes the lenticular lens sheet including a lamination with a front panel 19 according to the second embodiment of the present invention. FIGS. 5A and 5B are linked by the symbol (#). The front panel 19 is a light transmissive layer which serves also as a base of the lenticular lens sheet B described above. The front panel 19 may include a diffusion layer or may be coated with various functional films such as HC (hard coating), AG (anti-glare), AR (anti-reflection), and AS (anti-static) on the outermost layer of its light exit surface.

FIGS. 5A and 5B illustrate the transmission path of the light 100 which enters the lenticular lens sheet. As shown in FIGS. 5A and 5B, the overall structure of the lenticular lens sheet includes the front panel 19 and a functional film 20 in addition to the lenticular lens sheet B. The front panel 19 is adhered to the top surface of the self-aligned external light absorption layer 17 to serve as an integrated screen. Instead, the front panel 19 may be independent of the lenticular lens sheet B without being adhered to it.

The front panel 19 may be formed of an acrylic resin, polycarbonate resin, MS (methyl methacrylate-styrene copolymer) resin, polystyrene or the like. The front panel 19 may have a multi-layered structure including a single-layer diffusion plate or diffusion layer. The functional film 20 may be directly coated on the front panel 19 or a film coated with the functional film 20 may be laminated. The functional film 20 involves HC (hard coating), AG (anti-glare), AR (anti-reflection), AS (anti-static), or the like.

As shown in the top sectional view of FIG. 5A, the light 100 which is indent on the light incident surface of the lenticular lens sheet A is refracted by the first lens array 12 to propagate horizontally, passes through the first lens layer 14, is then focused in each lens medium of the second lens layer 15 and output. As shown in the cross sectional view of FIG. 5B, the light is refracted by the second lens array 13 in the vertical direction and focused in the second lens layer 15 and then output.

The self-aligned external light absorption layer 17 is placed in close proximity to the focus positions of the first lens array 12 and the second lens array 13. Provision of the self-aligned external light absorption layer 17 in the vicinity of the focus positions of both lenses increases contrast. Further, the focus position of the first lens array and the focus position of the second lens array may be located differently to thereby adjust the horizontal to vertical ratio of the light transmission portion. The self-aligned external light absorption layer 17 may be stripe-shaped.

As described above, the structure of the lenticular lens sheet according to the second embodiment of the present invention is that the self-aligned external light absorption layer 17 is placed on the light exit surface of the lenticular lens sheet A including the first lens array 12 and the second lens array 13 which are arranged perpendicular to each other in such a way that a light transmissive material is filled between the first lens array 12 and the self-aligned external light absorption layer 17, thereby allowing accurate positioning of the self-aligned external light absorption layer 17. Particularly, the self-aligned external light absorption layer 17 can be placed accurately such that the focus positions of both the first lens array 12 and the second lens array 13 are located close proximity to the position of the self-aligned external light absorption layer 17 according to the second embodiment, which further increases contrast.

Further, the lenticular lens sheet according to this embodiment of the present invention enables reduction of a diffusion material, which prevents image blur and improves the resolution. Furthermore, the lenticular lens sheet is composed of a single sheet, which eliminates damage due to contact of a plurality of lenticular lens sheets against each other. In addition, designing the pitch ratio of the first lens array and the second lens array to fall into a preferred range facilitates the production of a molding die and suppresses the occurrence of a moiré pattern.

A method of manufacturing the lenticular lens sheet according to the second embodiment of the present invention is described hereinafter. First, the second lens layer 15 having the second lens array 13 which is included in the lenticular lens sheet A is formed. For example, a base resin for the second lens layer 15 is melt-extruded by a T-die, and a cylindrical lens is formed on one side by a shaping roller. A maximum thickness of the second lens layer is substantially uniform.

The direction of transcription of the cylindrical lens with respect to the shaping roller may be horizontal in which the recessed groove array is parallel with the rotation axis center of the shaping roller, or may be vertical in which the recessed groove array is perpendicular to the rotation axis center. Instead of being melt-extruded, a base resin may be press-molded with a die having a recess groove on one side or may be molded on one side by injection molding.

On the second lens array 13, the first lens layer 14 having the first lens array 12 is formed with a light transmissive material having a lower refractive index than the second lens layer 15. The principal plane of the first lens array 12 should be substantially parallel with the light exit surface of the second lens layer 15 on which the self-aligned external light absorption layer 17 is placed. This is achieved easily by adjusting the tension of the base material of the second lens layer 15 and the viscosity of a transparent radiation curable resin. Alternatively, the first lens layer 14 may be molded as being pressed against a plate die using a hollow cylindrical transparent glass tube into which an ultraviolet radiation lamp is inserted. The above-described molding process preferably includes a process for facilitating adhesion such as plasma processing on the surface of the second lens array 13, for example.

Then, a film which is coated with a light shielding photocurable resin is adhered to the light exit surface of the second lens layer 15 of the lenticular lens sheet A integrated in the above process. Further, ultraviolet ray is applied through the light incident surface of the lenticular lens sheet. The light shielding photocurable resin at the position the ultraviolet ray focuses is thereby cured. After that, the film is stripped. The light shielding photocurable resin in the part where the ultraviolet light does not focus remains uncured in a lattice form on the light exit surface of the second lens layer 15. The light shielding photocurable resin in the part where the ultraviolet light focuses is stripped as being adhered to the film.

After that, the light shielding photocurable resin at the non-light-focusing portion which remains in a lattice form is cured by irradiation through the light exit surface of the lenticular lens sheet. The self-aligned external light absorption layer 17 is thereby formed. The process of forming the self-aligned external light absorption layer 17 is not limited to the above-described process. For example, it is possible to transcript a black layer of a photosensitive adhesive layer on the light exit surface of the second lens layer 15. Specifically, after forming a photosensitive adhesive layer on the light exit surface of the second lens layer 15, exposure light is applied from the light incident side to thereby form an exposed portion and a non-exposed portion corresponding the shape and pitch of the lens portion on the photosensitive adhesive layer. Then, a black layer is formed on the surface of the photosensitive adhesive layer and transcribed onto only the non-exposed portion of the photosensitive adhesive layer by lamination. The self-aligned external light absorption layer 17 is thereby formed. The exposed portion is a relatively high-density exposed part, and the non-exposed portion is a relatively low-density exposed part. Thus, the non-exposed portion is not limited to a part which is not exposed at all.

Further, it is possible to form the self-aligned external light absorption layer 17 by using a difference in surface free energy between the exposed portion and the non-exposed portion. For example, a layer of 100 parts by mass photocurable resin composition (A) with the surface free energy of 30 mN/m or higher and 0.01 to 10 parts by mass of compound (B) with the surface free energy of 25 mN/m or lower is formed on the light exit surface of the second lens layer 15. Then, exposure light is applied from the lens portion side as being in contact with a medium (e.g. atmosphere) having a lower surface free energy than the compound (B). The applied light is focused through the lens so that only the photocurable resin composition (A) at the light focusing position is selectively cured. A lens sheet having the surface free energy of 25 mN/m or lower at the light focusing position is thereby obtained.

Then, light is applied to the obtained lens sheet from the light exit surface side as being in contact with a medium (e.g. water) having a higher surface free energy than the photocurable resin composition (A). Only the photocurable resin composition (A) is thereby cured. The surfaces with different surface free energy have different wettability, and for general solvent or coating, the wettability to liquid is higher in the surface with a higher surface free energy than the surface with a lower surface free energy. Accordingly, in the lens sheet whose surface property is selectively modified, the non-light-focusing portion has higher wettability to each liquid than the light-focusing portion. Because of such characteristics, application of colored coating on the surface-modified lens sheet enables the formation of a light shielding pattern in which the colored coating is deposited only on the non-light-focusing portion.

After that, the front panel 19 is laminated on the self-aligned external light absorption layer 17. The lamination may be formed by adhesion using a radiation curable resin or adhesion using adhesive.

Further, the functional film 20 may be laminated on the surface of the front panel 19. Specifically, the functional film 20 may be coated directly on the front panel 19 or a film coated with the functional film 20 may be laminated.

By the above-described manufacturing method, the lenticular lens sheet having the structure shown in FIGS. 4, 5A and 5B is produced.

### Third Embodiment

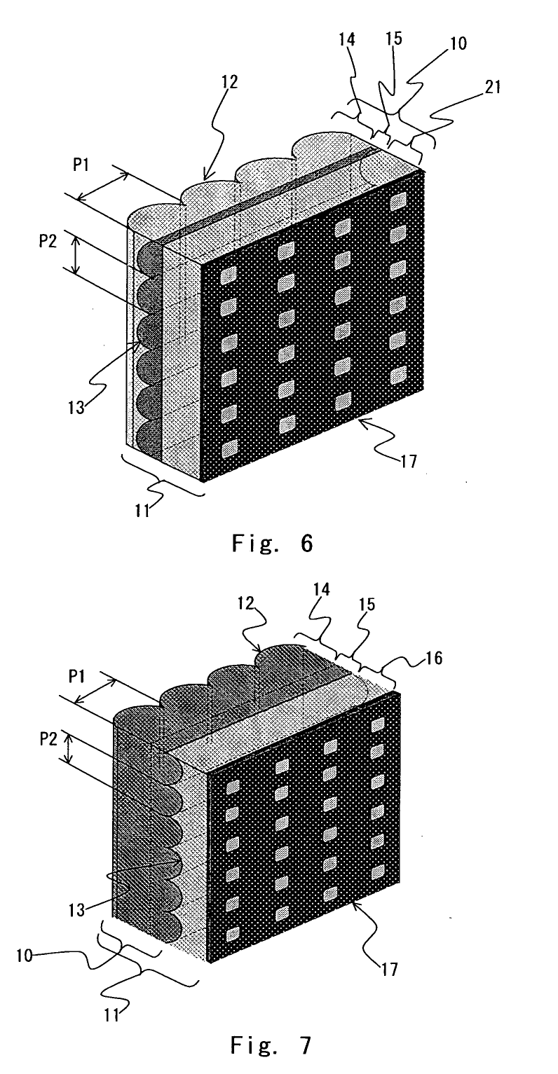

FIG. 6 is a perspective view showing the structure of the main part of the lenticular lens sheet according to a third embodiment of the present invention.

The third embodiment is different from the second embodiment in the lenticular lens sheet A that a transparent base 21 is placed on the light exit side of the second lens layer 15 and the self-aligned external light absorption layer 17 is placed on the light exit surface of the transparent base 21. The other structure is the same as that of the second embodiment and thus not described herein.

The transparent base 21 may be an acrylic resin film, MS resin film, PET film, or the like.

Because the lenticular lens sheet according to the third embodiment of the present invention has the self-aligned external light absorption layer 17 on the light exit surface of the transparent base 21 which includes the first lens array 12 and the second lens array 13 arranged perpendicular to each other, the self-aligned external light absorption layer 17 can be placed accurately. Particularly, the third embodiment enables accurate positioning of the self-aligned external light absorption layer 17 such that the focus positions of both the first lens array 12 and the second lens array 13 are located close proximity to the position of the self-aligned external light absorption layer 17, thereby further increasing contrast.

A method of manufacturing the lenticular lens sheet according to a third embodiment of the present invention is described hereinafter.

Firstly, the second lens layer 15 having the second lens array 13 is formed on the light incident surface of the transparent base 21. For example, a transparent radiation curable resin is coated directly on the surface of the transparent base 21. Alternatively, a transparent radiation curable resin may be coated on a shaping roller or on both surfaces and then cured by irradiation.

The direction of transcription of the cylindrical lens with respect to the shaping roller may be horizontal in which the recessed groove array is parallel with the rotation axis center of the shaping roller, or may be vertical in which the recessed groove array is perpendicular to the rotation axis center. Instead of a shaping roller, a plate die having a recess groove on one side may be used.

Then, on the second lens array 13 which serves as the light incident surface of the second lens layer 15 integrated with the transparent base 21 obtained in the above process, the first lens layer 14 is formed with a transparent radiation curable resin having a lower refractive index than the second lens layer 15. The first lens layer 14 is formed in such a way that the first lens array 12 is substantially perpendicular to the second lens array 13. The principal plane of the first lens array 12 should be substantially parallel with the principal plane of the second lens array 13. The accurate and uniform formation can be achieved easily by adjusting the tension to be applied to the base material of the transparent base 21 integrated with the second lens layer 15 and optimizing the viscosity of the transparent radiation curable resin for the first lens layer.

Alternatively, the first lens layer 14 may be molded as being pressed against a plate die using a hollow cylindrical transparent glass tube into which an ultraviolet radiation lamp is inserved. The above-described molding process preferably includes a process for facilitating adhesion such as plasma processing on the surface of the second lens array 13, for example.

Further, a film coated with a light shielding photocurable resin is adhered onto the surface of the transparent base 21 as the light exit surface of the lenticular lens sheet A integrated in the above process, and the self-aligned external light absorption layer 17 is formed by the method described in the second embodiment.

The lenticular lens sheet having the structure shown in FIG. 6 is produced by the above manufacturing method.

### Fourth Embodiment

FIG. 7 is a perspective view showing the structure of the main part of the lenticular lens sheet according to a fourth embodiment of the present invention. In the fourth embodiment, the part of the lenticular lens sheet which includes the first lens layer 14 and the second layer 15 is referred to as a lenticular lens sheet A (denoted by the reference numeral “10”), and the lenticular lens sheet which further includes a packed layer 16 and the self-aligned external light absorption layer 17 in addition to the lenticular lens sheet A is referred to as a lenticular lens sheet B (denoted by the reference numeral “11”). The lenticular lens sheet A has the first lens array 12 on the light incident surface and the second lens array 13, which is arranged perpendicular to the first lens array 12, on the light exit surface. In the fourth embodiment, the refractive index of the combination of the lens layers constituting the lenticular lens sheet A is higher than the refractive index of the packed layer 16.

The first lens array 12 is the same as that of the second embodiment and thus not described herein.

The second lens array 13 includes a plurality of convex lenses which are placed on the front side (incident side) when viewed from the light exit plane side. The lenses are vertically fluted cylindrical lenses which are arranged in parallel with each other. Thus, the second lens array 13 is substantially perpendicular to the first lens array 12. Accordingly, due to the refractive index and the lens shape, the second lens array can focus incident light inside a lens medium and then diffuse the light in the vertical direction on the light exit surface.

On the light exit surface of the lenticular lens sheet A, the packed layer 16 which is filled with a resin is placed. The packed layer 16 is in contact with the lens interface of the second lens array 13 to cover it. The surface of the packed layer 16 which is opposite to the surface in contact with the second lens array 13 is flat and in parallel with the principal plane of the lenticular lens sheet A.

Because the second lens array 13 which serves as the light exit surface of the lenticular lens sheet A is formed at the interface with the packed layer 16, it can be perceived also as being formed on the packed layer 16. If it is perceived as a lens which is formed on the packed layer 16, the lenticular lens is concave when viewed from the light incident side.

The packed layer 16 should have a different refractive index from the second lens layer, and it may be formed of a radiation curable resin, for example. In the fourth embodiment, when the second lens array 13 which is formed on the light exit surface of the lenticular lens sheet A functions as a convex lens to focus light as shown in FIG. 7, the refractive index of the packed layer 16 should be lower than the refractive index of the lenticular lens sheet A. For example, an acrylic ultraviolet curable resin with the refractive index of 1.49 may be used for the packed layer 16, a MS resin with the refractive index of 1.58 may be used for the first lens layer 14 of the lenticular lens sheet A, and a MS ultraviolet curable resin with substantially the same refractive index may be used for the second lens layer 15 of the lenticular lens sheet A.

Further, the self-aligned external light absorption layer 17 is formed on a flat light exit surface of the packed layer 16. The self-aligned external light absorption layer 17 is placed on the non-light-focusing portions, which are the non-light-transmission portions, of the first lens array 12 and the second lens array 13. In the fourth embodiment, the self-aligned external light absorption layer 17 is formed in a lattice pattern. The self-aligned external light absorption layer 17 may be formed of a light shielding photocurable resin.

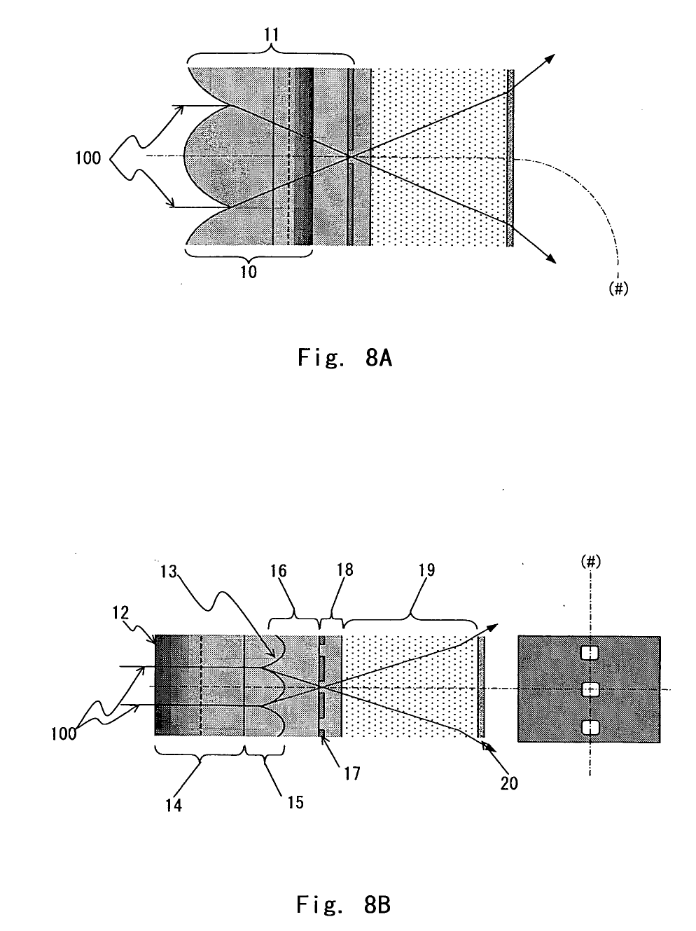

FIGS. 8A and 8B are a top sectional view and a cross sectional view of the lenticular lens sheet including the lamination with the front panel 19 according to the fourth embodiment of the present invention. FIGS. 8A and 8B also illustrate the transmission path of the light 100 which enters the lenticular lens sheet. FIGS. 8A and 8B are linked by the symbol (#).

As shown in the top sectional view of FIG. 8A, the light 100 which is incident on the light incident surface of the lenticular lens sheet A is refracted by the second lens array 13, focused in each lens medium of the lenticular lens sheet A and the packed layer 16 and then output.

As shown in the cross sectional view of FIG. 8B, the light is refracted by the second lens array 13 in the vertical direction, focused in the packed layer 16 and then output. Thus, the self-aligned external light absorption layer 17 is placed in close proximity to the focus positions of the first lens array 12 and the second lens array 13. Provision of the self-aligned external light absorption layer 17 in the vicinity of the focus positions of both lenses further increases contrast.

As described above, the structure of the lenticular lens sheet according to the fourth embodiment of the present invention is that the packed layer 16 is placed on the light exit surface of the lenticular lens sheet A including the lens arrays 12 and 13 which are arranged perpendicular to each other and the self-aligned external light absorption layer 17 is placed on the packed layer 16 in such a way that the light transmissive material is filled between the first lens array 12 and the self-aligned external light absorption layer 17. This allows accurate positioning of the self-aligned external light absorption layer 17 relative to the lens arrays 12 and 13 and the packed layer 16.

Particularly, the self-aligned external light absorption layer 17 can be placed accurately such that the focus positions of both the first lens array 12 and the second lens array 13 are located close proximity to the position of the self-aligned external light absorption layer 17 according to the fourth embodiment, which further increases contrast. Further, the lenticular lens sheet according to this embodiment of the present invention enables reduction of a diffusion material, which prevents image blur and improves the resolution.

A method of manufacturing the lenticular lens sheet according to the fourth embodiment of the present invention is described hereinafter.

First, the first lens layer 14 having the first lens array 12 which is included in the lenticular lens sheet A is formed. For example, a base resin for the first lens layer 14 is melt-extruded by a T-die, and a cylindrical lens is formed on one side by a shaping roller. The direction of transcription of the cylindrical lens with respect to the shaping roller may be horizontal in which the recessed groove array is parallel with the rotation axis center of the shaping roller, or may be vertical in which the recessed groove array is perpendicular to the rotation axis center.

Instead of being melt-extruded, a base resin may be press-molded with a die having a recess groove on one side or molded on one side by injection molding.

Then, the second lens layer 15 having the second lens array 13 is formed with a transparent radiation curable resin having substantially the same refractive index as the base resin of the first lens layer 14 on the light exit surface of the base material of the first lens layer 14 obtained in the above process. The second lens layer 15 is formed in such a way that the second lens array 13 is substantially perpendicular to the first lens array 12. The principal plane of the second lens layer 15 should be substantially parallel with the principal plane of the first lens layer 14. The lens interval of each lens array can be set accurately and uniformly by adjusting the tension to be applied to the base material of the first lens layer 14 and optimizing the viscosity of the transparent radiation curable resin for the second lens layer 15.

When molding the second lens array 13 with a transparent radiation curable resin, the base material of the first lens layer 14 which is molded by extrusion may be placed around a die shaping roller and irradiated to be cured. Alternatively, the second lens array 13 may be molded as being pressed against a plate die using a hollow cylindrical transparent glass tube into which an ultraviolet radiation lamp is inserted. The above-described molding process preferably includes a process for facilitating adhesion such as plasma processing on the surface of the second lens array 13, for example.

After that, the packed layer 16 having a lower refractive index than the second lens layer 15 is formed of a transparent radiation curable resin on the second lens array 13. The principal plane of the packed layer 16 on which the self-aligned external light absorption layer 17 is placed should be substantially parallel with the principal plane of the lane layers. This is achieved easily by adjusting the tension to be applied to the lenticular lens sheet A which is integrated in the above process and optimizing the viscosity of the transparent radiation curable resin.

Further, a film coated with a light shielding photocurable resin is adhered onto the surface of the packed layer 16, and the self-aligned external light absorption layer 17 is formed by the method described in the second embodiment.

The lenticular lens sheet having the structure shown in FIG. 7 is produced by the above manufacturing method.

### Fifth Embodiment

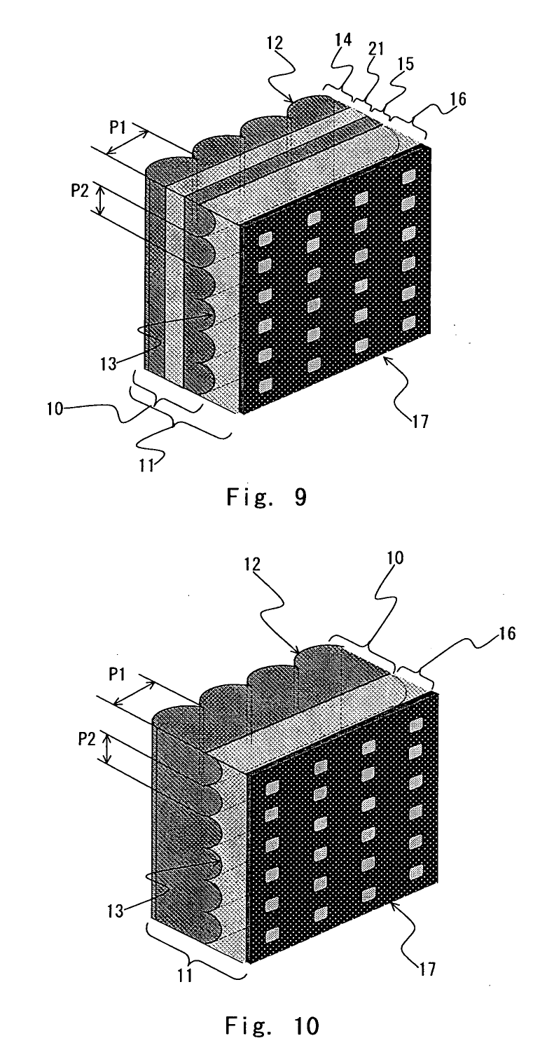

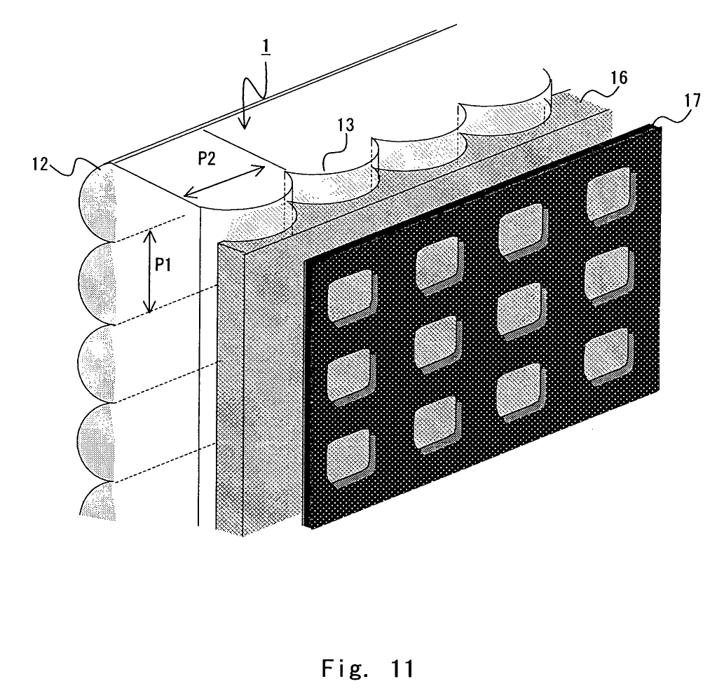

FIG. 9 is a perspective view showing the structure of the main part of the lenticular lens sheet according to a fifth embodiment of the present invention. The fifth embodiment is different from the fourth embodiment in that the first lens layer 14 and the second lens layer 15 are placed on the transparent base 21. The other structure is the same and thus not described herein.

The lenticular lens sheet according to the fifth embodiment of the present invention has the same advantage as the lenticular lens sheet according to the fourth embodiment.

A method of manufacturing the lenticular lens sheet according to the fifth embodiment of the present invention is described hereinafter.

Firstly, the first lens layer 14 having the first lens array 12 is formed on one side of the transparent base 21. For example, a transparent radiation curable resin may be coated on the transparent base 21 or the surface of a shaping roller and adhered together, or coated on both surfaces and adhered together, then irradiated from the side of the transparent base 21 to be cured. The thickness of the first lens layer 14 can be set accurately and uniformly by adjusting the tension to be applied to the base material of the transparent base 21 and optimizing the viscosity of the transparent radiation curable resin.

The direction of transcription of the cylindrical lens with respect to the shaping roller may be horizontal in which the recessed groove array is parallel with the rotation axis center of the shaping roller, or may be vertical in which the recessed groove array is perpendicular to the rotation axis center.

Then, on the surface of the transparent layer 21 which is opposite to the surface adhered with the first lens layer 14, the second lens layer 15 having the second lens array is formed of a transparent radiation curable resin. The second lens layer 15 is formed in such a way that the second lens array 13 is substantially perpendicular to the first lens array 12. The principal plane of the second lens array 13 should be substantially parallel with the principal plane of the first lens array 12. The lens interval of each lens array can be set accurately and uniformly by adjusting the tension to be applied to the base material of the transparent layer 21 which is adhered with the first lens layer 14 and integrated therewith and optimizing the viscosity of the transparent radiation curable resin for the second lens layer 15. Further, the above-described molding process preferably includes a process for facilitating adhesion such as plasma processing on the surface of the transparent base 21, for example.

After that, the packed layer 16 having a lower refractive index than the second lens layer 15 is formed of a transparent radiation curable resin on the second lens array 13. The principal plane of the packed layer 16 on which the self-aligned external light absorption layer 17 is placed should be substantially parallel and equally thick with the principal plane of the first and second lens arrays. This is achieved easily by adjusting the tension to be applied to the lenticular lens sheet A which is integrated with the lens layers and optimizing the viscosity of the transparent radiation curable resin.

The process of molding a transparent radiation curable resin on the transparent base 21 is not limited to the above-described process. For example, it is possible to form the second lens layer 15 firstly on the surface of the transparent base 21. It is also possible to form the second lens layer 15 firstly, then form the packed layer 16 in the following step, and finally form the first lens layer 14.

Further, the transparent base 21 may be placed around a shaping roller in succession and irradiated to be cured. Alternatively, it may be molded as being pressed against a plate die using a hollow cylindrical transparent glass tube into which an ultraviolet radiation lamp is inserted. The above-described molding process preferably includes a process for facilitating adhesion such as plasma processing on the surface of the second lens array 13, for example.

Further, a film coated with a light shielding photocurable resin is adhered onto the surface of the packed layer 16, and the self-aligned external light absorption layer 17 is formed by the method described in the second embodiment.

### Sixth Embodiment

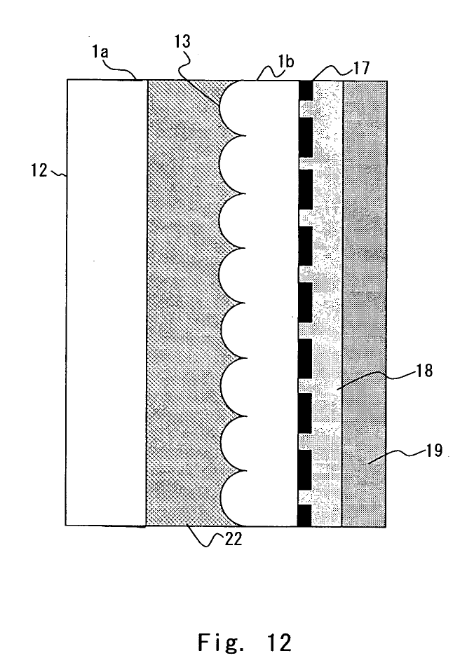

FIG. 10 is a perspective view showing the structure of the main part of the lenticular lens sheet according to a sixth embodiment of the present invention. Although the lenticular lens sheet according to the sixth embodiment of the present invention has the same structure as the lenticular lens sheet according to the fourth embodiment shown in FIG. 7, the manufacturing method is different as described hereinbelow.

Firstly, the lenticular lens sheet A is produced. For example, a base resin for the lens sheet is melt-extruded by a T-die, and cylindrical lens arrays on both sides are formed at the same time by a shaping roller. The transcription of the cylindrical lenses with the shaping roller is performed at the same time by the combination of a horizontal groove roller in which the recessed groove array is parallel with the rotation axis center of the shaping roller and a vertical groove roller in which the recessed groove array is perpendicular to the rotation axis center.

Instead of the melt-extrusion molding, a base resin may be press-molded with a two-sided die, or the lens arrays on both sides may be molded at the same time by injection molding.

After that, the packed layer 16 having a lower refractive index than the lens layer of the lenticular lens sheet A is formed of a transparent radiation curable resin. The principal plane of the packed layer 16 on which the self-aligned external light absorption layer 17 is placed should be substantially parallel with the principal plane of the two-sided cylindrical lens sheet. This is achieved easily by adjusting the tension to be applied to the two-sided cylindrical lens sheet and optimizing the viscosity of the transparent radiation curable resin.

When molding the packed layer 16 with a transparent radiation curable resin, the base material of the lenticular lens sheet A which is molded by extrusion may be placed around a die shaping roller and irradiated to be cured. Alternatively, it may be molded as being pressed against a plate die using a hollow cylindrical transparent glass tube into which an ultraviolet radiation lamp is inserted. The above-described molding process preferably includes a process for facilitating adhesion such as plasma processing on the surface of the second lens array 13, for example.

Further, a film coated with a light shielding photocurable resin is adhered onto the surface of the packed layer 16, and the self-aligned external light absorption layer 17 is formed by the method described in the second embodiment.

### Seventh Embodiment

Although the lenticular lens sheets according to the above-described second to sixth embodiments of the present invention are configured to have a combination of the lens shape and the refractive index such that the first lens array controls the diffusion in the horizontal direction and the second lens array controls the diffusion in the vertical direction, it may be opposite. Specifically, the first lens array may be a horizontally fluted cylindrical lens array, and the second lens array may be a vertically fluted cylindrical lens array as shown in FIG. 11.

### Eighth Embodiment

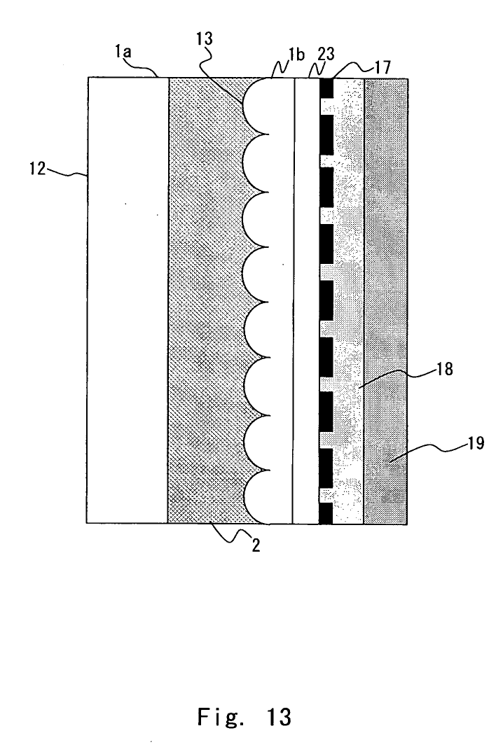

FIG. 12 shows a cross section of a lenticular lens sheet according to an eighth embodiment of the present invention. In the eighth embodiment, two sets of lenticular lens sheets 1a and 1b are used. The lenticular lens sheet 1a has the first lens array 12 which is arranged vertically with respect to the light incident surface. The light exit surface of the lenticular lens sheet 1a is flat, and a self-aligned external light absorption layer is not formed thereon. The lenticular lens sheet 1b has the second lens array 13 which is arranged horizontally with respect to the light incident surface. Thus, the first lens array 12 and the second lens array 13 are substantially perpendicular to each other.

The self-aligned external light absorption layer 17 is formed on the light exit surface of the lenticular lens sheet 1b. The self-aligned external light absorption layer 17 is placed at the non-light-focusing portions which are in close proximity to the focus positions of both the first lens array 12 and the second lens array 13. In the eighth embodiment, the self-aligned external light absorption layer 17 is formed in a lattice pattern.

A packed layer 22 is placed between the lenticular lens sheet 1a and the lenticular lens sheet 1b. Due to the presence of the packed layer 22, the lenticular lens sheet 1a and the lenticular lens sheet 1b can be placed accurately relative to each other. Particularly, because the first lens array 12 which is formed in the lenticular lens sheet 1a should be placed in close proximity to the self-aligned external light absorption layer 17 placed on the light exit surface of the lenticular lens sheet 1b, the effect of accurate positioning of the lenticular lens sheet 1a and the lenticular lens sheet 1b is advantageous in terms of this point.

The packed layer 22 is may be formed of a 2P resin. The 2P resin is an ultraviolet curable resin, and a ultraviolet curable fluorine resin may be used for example. The packed layer 22 should have a different refractive index from the lenticular lens sheet 1b. If the second lens array 13 formed on the light incident surface of the lenticular lens sheet 1b is convex toward the incident side as shown in FIG. 12, the refractive index of the packed layer 22 should be lower than the refractive index of the lenticular lens sheet 1b. On the contrary, if the second lens array 13 is concave toward the incident side, the refractive index of the packed layer 22 should be higher than the refractive index of the lenticular lens sheet 1b.

On the light exit surface of the lenticular lens sheet 1b, the transparent sheet 18 and the front panel 19 are formed. The transparent sheet 18 and the front panel 19 are the same as those described in the second embodiment and thus not described herein.

As described in the foregoing, the structure of the lenticular lens sheet according to the eighth embodiment of the present invention is that the packed layer 22 is placed between the lenticular lens sheet 1a having the first lens array 12 and the lenticular lens sheet 1b having the second lens array 13. On the light exit surface of the lenticular lens sheet 1b, the self-aligned external light absorption layer 17 is placed in such a way that a light transmissive material is filled between the first lens array 12 and the self-aligned external light absorption layer 17. This allows accurate positioning of the self-aligned external light absorption layer 17 relative to the lens arrays 12 and 13. Particularly, the self-aligned external light absorption layer 17 can be placed accurately such that the focus positions of both the first lens array 12 and the second lens array 13 are located close proximity to the position of the self-aligned external light absorption layer 17 according to the eighth embodiment, which further increases contrast.

The lenticular lens 12 in the lenticular lens sheet 1a may be formed on the light exit surface.

A method of manufacturing the lenticular lens sheet according to the eighth embodiment of the present invention is described hereinafter.

Firstly, the lenticular lens sheets 1a and 1b are produced. For example, a base resin for the lens sheet is melt-extruded with a T-die, and cylindrical lenses on both sides are formed at the same time with a shaping roller. Alternatively, it is possible to melt-extrude a base material with a T-die, form cylindrical lenses on the light incident side with a shaping roller, and then form cylindrical lenses on the light exit side by 2P with a different die. Further, alternatively, a base resin may be press-molded with a two-sided (top and bottom) die. The base resin and the molding process for the lenticular lens sheets 1a and 1b may be the same or different.

Then, a 2P resin having a different refractive index from the base resin for the lenticular lens sheet 1b is filled on the light exit surface of the lenticular lens sheet 1a to thereby form the packed layer 22. Further, the lenticular lens sheet 1b is placed on the packed layer 22. After that, ultraviolet light is applied to the packed layer 22 so that the packed layer 22 is cured. Further, a film coated with a light shielding 2P resin is adhered onto the top surface of the packed layer 22, and the self-aligned external light absorption layer 17 is formed by the method described in the second embodiment.

On the self-aligned external light absorption layer 17, the transparent sheet 18 having substantially the same refractive index as the lenticular lens sheet 1 is laminated. The lamination may be formed by adhesion by a low-refractive index 2P resin or adhesion by a low-refractive index adhesive.

Further, the functional film 19 is laminated on the transparent sheet 18. Specifically, the functional film 19 may be coated directly on the transparent sheet 18 or a film coated with the functional film 19 may be laminated.

By the above-described manufacturing method, the lenticular lens sheet having the structure shown in FIG. 12 is produced.

### Ninth Embodiment

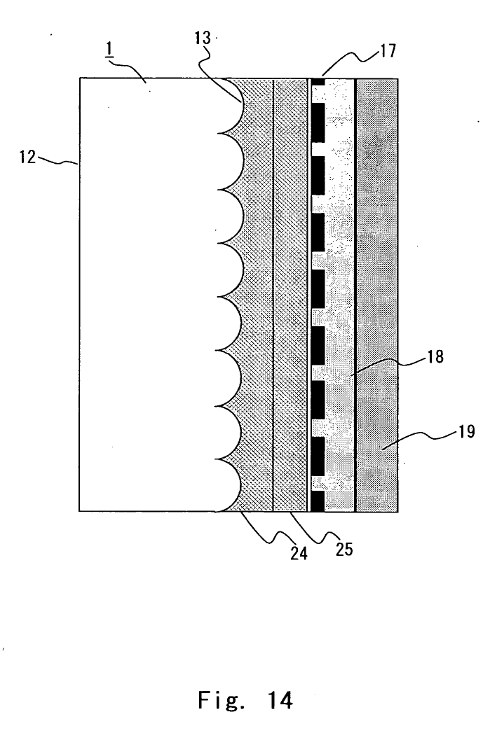

FIG. 13 shows a cross section of a lenticular lens sheet according to a ninth embodiment of the present invention. The lenticular lens sheet according to the ninth embodiment has basically the same structure as the lenticular lens sheet according to the eighth embodiment, and the only difference is that a transparent sheet 23 is placed on the light exit surface of the lenticular lens sheet 1b and the self-aligned external light absorption layer 17 is placed on the light exit surface of the transparent sheet 23. Such a structure has the same advantage as in the eighth embodiment. The manufacturing method of the lenticular lens sheet according to the ninth embodiment is the same as that of the eighth embodiment and not described herein.

### Tenth Embodiment

As shown in the cross sectional view of FIG. 14, the packed layer may be made up of two or more layers, i.e. packed layers 24 and 25.

Although the lenticular lens sheet 1 described in the above embodiments has a single-sheet structure, it is possible to form the lens arrays 12 and 13 on each of two sheets and adhere them together.

The lenticular lens sheet according to the present invention may be used in a rear projection-type projection device such as a rear projection-type projection television or monitor.

### Eleventh Embodiment

A Fresnel lens which is employed in the present invention is used in the condition that light is incident thereon obliquely as shown in FIG. 3. In such a case, a preferred structure is that a prism array is formed on the light incident side and at least part of the incident light is output by total reflection. This is because a normal Fresnel lens sheet which has a prism array only on either light exit surface or light incident surface and deflects or focuses incident light by refraction only has low light use efficiency.

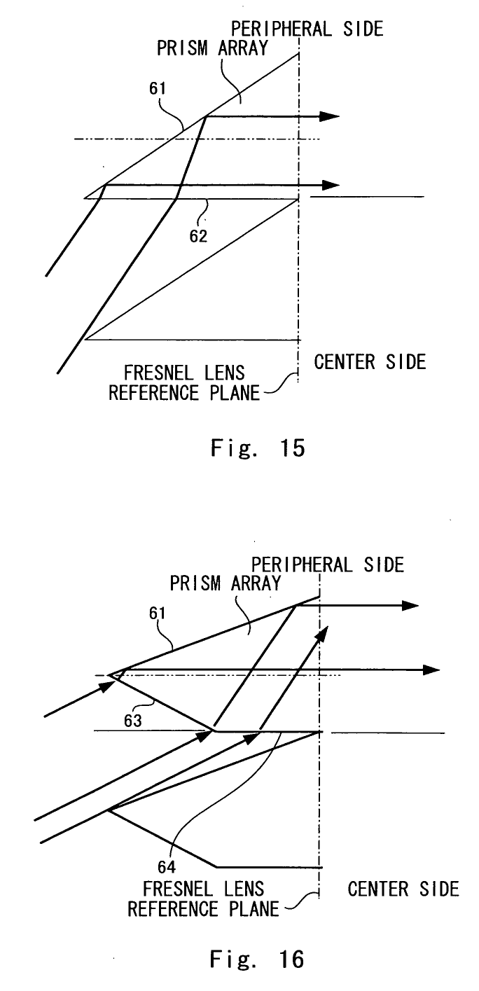

FIG. 15 shows a Fresnel lens sheet according to an eleventh embodiment of the present invention. The Fresnel lens sheet has a triangular prism array on the light incident side so that the light incident on an incident surface 61 is refracted by the incident surface 61 toward a reflective surface 62 and then totally reflected by the reflective surface 62 and output.

Provision of a narrow connecting part at the top or valley of the prism array structure facilitates the manufacture of a molding die or the removal of a product from the molding die. The width of the connecting part is preferably 3 μm to 15 μm. If it is less than 3 μm, the manufacture of a molding die or the removal of a molded product cannot be improved sufficiently. If it is more than 15 μm, a light use efficiency decreases and the incident light on the connecting part can be extraordinary ray or “ghost”, which are not undesirable.

### Twelfth Embodiment

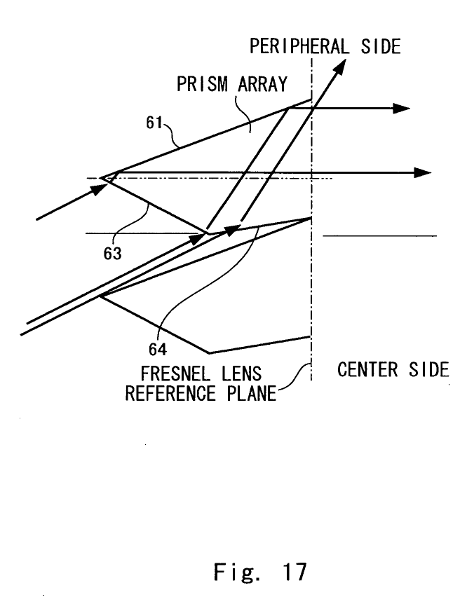

FIG. 16 shows another embodiment of the invention. In this structure, one edge of the triangular prism array shown in FIG. 15 is cut so that the cut surface serves as an incident surface 63 and the reflective surface 62 and a rise surface 64 are provided. Such a structure reduces the height of the prisms and increases the edge angle, which facilitates the manufacture of a molding die or the removal of a product from the molding die while keeping a high light transmittance.

### Thirteenth Embodiment

FIG. 17 shows yet another embodiment of the invention. The structure of FIG. 17 is different from the structure of FIG. 16 in that the rise surface 64 is tilted to reduce the angle between the rise surface 64 and the reflective surface 62. This embodiment reduces the proportion of the light incident on the rise surface 64 to increase light use efficiency, which is particularly preferable. The tilt of the rise surface 64 is preferably from 1 to 20 degrees and more preferably from 2 to 10 degrees. If it is less than 1 degree, the light use efficiency cannot be sufficiently high. If, on the other hand, it is more than 20 degree, the manufacture of a molding die can be difficult. Although it is apparently difficult to remove a molded product as shown in FIG. 17 from a molding die, it is not if the product is removed from the upper part because the optical center OC of the Fresnel lens is located outside the sheet in this invention.

### Fourteenth Embodiment

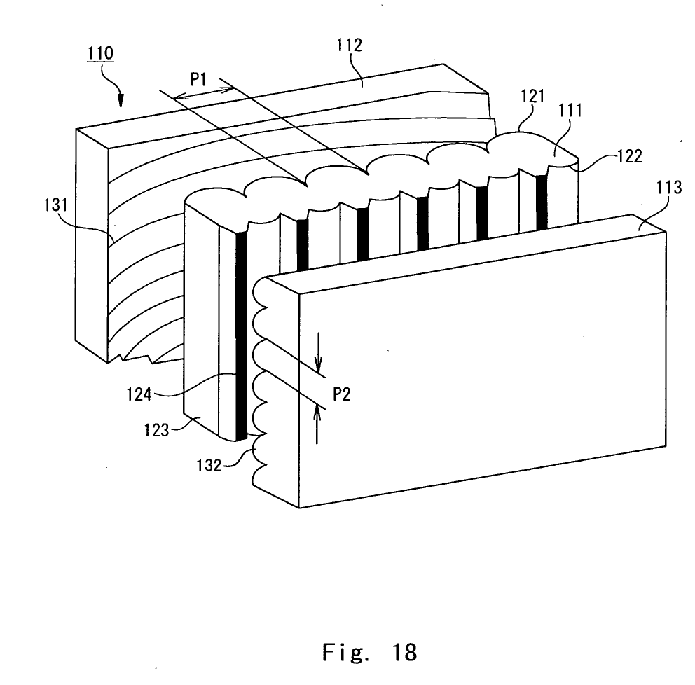

FIG. 18 is a perspective view showing a partial structure of a rear projection-type screen according to a fourteenth embodiment of the present invention. In the rear projection-type screen 110, the lenticular lenses 121 on the lenticular lens sheet 111 serve as a first lens array. With respect to the lenticular lenses 121, a second lens array 132 is placed on the front panel 113. The second lens array 132 projects from the light input surface of the front panel 113 and arranged substantially perpendicularly to the lenticular lenses 121. In other words, the second lens array 132 is arranged in the longitudinal direction of the lenticular lenses 121 at lens pitch P2. The rear projection-type screen 110 having such a structure prevents the occurrence of moiré in the horizontal direction (i.e. the arrangement direction of the lenticular lenses 121) by the combination of the lenticular lens sheet 111 and the Fresnel lens sheet 112.

### Other Embodiments

In the above-described first to thirteenth embodiments of the present invention, the present invention is applied to the lenticular lens sheet. However, the present invention is applicable not only to the lenticular lens sheet but also to various microlens array sheets. In such a case, if the lens pitch of a Fresnel lens is Pf (mm), and the effective pitch of a microlens array in substantially horizontal direction is P1*(mm), the microlens array satisfies any one of the following equations (1*) to (3*).

$$\begin{matrix}\frac{P {1}^{★}}{Pf} = i + 0.0 \sim 0.35 or \frac{P {1}^{★}}{Pf} = \frac{1}{i + 0.0 \sim 0.35} & ( {1}^{★} ) \\ \frac{P {1}^{★}}{Pf} = i + 0.45 \sim 0.55 or \frac{P {1}^{★}}{Pf} = \frac{1}{i + 0.45 \sim 0.55} & ( {2}^{★} ) \\ \frac{P {1}^{★}}{Pf} = i + 0.65 \sim 1.0 or \frac{P {1}^{★}}{Pf} = \frac{1}{i + 0.65 \sim 1.0} & ( {3}^{★} )\end{matrix}$$

where i represents a natural number of 12 or below.

Further, the microlens array satisfies either of the following equations (4*) or (5*) and further satisfies the equation (6*) when the effective pitch of a microlens array in substantially the vertical direction is P2*(mm), the pitch of a lattice in the screen diagonal direction by P1* and P2* is P*(mm) which is calculated from the following equation (7*), and the pitch of a moiré pattern by P* and Pf is PM*(mm).

$$\begin{matrix}\frac{P {2}^{★}}{Pf} = i + 0.35 \sim 0.45 or \frac{P {2}^{★}}{Pf} = \frac{1}{i + 0.35 \sim 0.45} & ( {4}^{★} ) \\ \frac{P {2}^{★}}{Pf} = i + 0.55 \sim 0.65 or \frac{P {2}^{★}}{Pf} = \frac{1}{i + 0.55 \sim 0.65} & ( {5}^{★} ) \\ {PM}^{★} = \frac{1}{\vert \frac{1}{{P}^{★}} - \frac{1}{Pf} \vert} \leq 3 ( mm ) & ( {6}^{★} ) \\ {P}^{★} = \frac{1}{\sqrt{\frac{1}{{n}^{2} P {1}^{{★}^{2}}} + \frac{1}{{m}^{2} P {2}^{{★}^{2}}}}} & ( {7}^{★} )\end{matrix}$$

where i represents a natural number of 12 or below, and n and m represent natural numbers of 4 or below.

When the present invention is applied to a microlens array sheet, the effective pitches P1* and P2* of the microlens array in substantially horizontal and vertical directions are required. The effective pitches P1* and P2* indicate an accrual interval between microlenses in substantially horizontal and vertical directions. Specifically, the effective pitch P1* can be a distance between the centers of the microlenses which are adjacent in substantially vertical direction. Similarly, the effective pitch P2* in substantially the horizontal direction can be a distance between the centers of the microlenses which are adjacent in substantially horizontal direction.

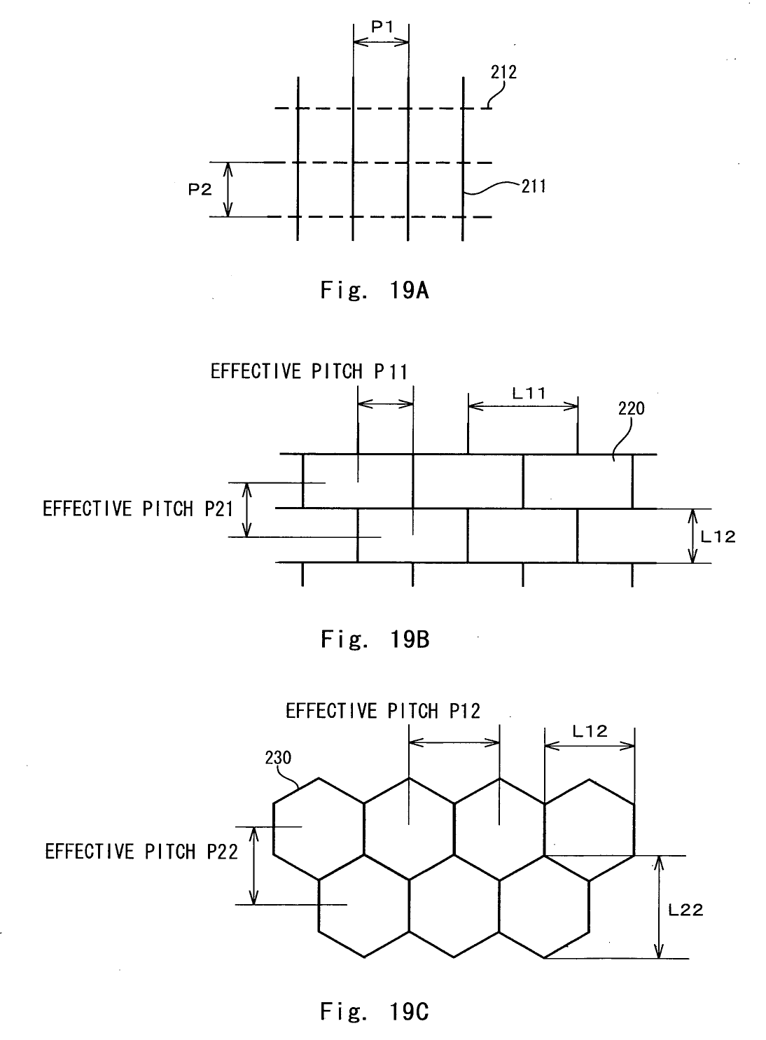

In this embodiment, the effective pitches in the microlens pitch are described hereinafter in detail with reference to FIGS. 19A, 19B and 19C. In this specification, the effective pitches and the values calculated from the effective pitches are denoted by the symbol “*” to indicate the values related to the effective pitches.

FIG. 19A shows the case with the same structure as that of the above-described lenticular lens sheet. Specifically, the microlens arrays 211 and 212 are respectively arranged substantially vertically and horizontally at substantially the same pitches. In such a case, as in the above-described lenticular lens sheet, the distances between the longitudinal axes of the microlens arrays 211 and 212 are respectively the effective pitches P1* and P2*. They thus correspond to the lens pitches P1 and P2 of the lens arrays 12 and 13 described above.

FIG. 19B shows an example of a delta array in which the microlenses having substantially rectangular shape when viewed from top are shifted from each other in substantially vertical direction. Specifically, the microlens 220 having substantially rectangular shape when viewed from top are arranged substantially horizontally at substantially the same pitch. Further, another microlens array 220 which are arranged below (or above) the microlens array 220 is shifted in substantially horizontal direction with respect to the microlenses 220. In FIG. 19B, a symbol “1” is substituted into the symbol “*” indicating the effective pitch.

In FIG. 19B, the substantially horizontal effective pitch P1* of the microlenses 220 is a center distance P11 of the microlenses 220 in substantially horizontal direction. It is assumed that the microlenses 220 have substantially the same shape when viewed from top and the shift width of the microlenses 220 is about half the width L11 in substantially horizontal direction of the microlenses 220. In such a case, the center distance P11 of the microlenses 220 in substantially horizontal direction is about half the width L11 of the microlenses 220 in substantially horizontal direction.

The substantially vertical effective pitch P2* of the microlenses 220 is a center distance P21 of the microlenses 220 in substantially vertical direction. The microlenses 220 are not shifted in the substantially vertical direction, unlike in the substantially horizontal direction. Thus, if the microlenses 220 have substantially the same shape when viewed from top, the center distance P21 equals the width L21 of the microlenses 220 in substantially vertical direction.

FIG. 19B shows an example of a delta array in which polygonal-shaped microlenses are arranged. Specifically, the microlenses 230 having substantially hexagonal shape when viewed from top are arranged with each side adjacent to each other. In FIG. 19C, a symbol “2” is substituted into the symbol “*” indicating the effective pitch.

In FIG. 19C, the substantially horizontal effective pitch P1* of the microlenses 230 is a center distance P12 of the microlenses 230 in substantially horizontal direction. If the microlenses 230 have substantially the same shape when viewed from top, the center distance P12 of the microlenses 230 in substantially horizontal direction equals half the width L12 of the microlenses 230 in substantially horizontal direction. The substantially horizontal width L12 of the microlenses 230 shown in FIG. 19C is a distance between two opposing sides.

Similarly, the substantially vertical effective pitch P2* of the microlenses 230 is a center distance P22 of the microlenses 230 in substantially vertical direction. If the microlenses 230 have substantially the same shape when viewed from top, the center distance P22 equals 0.75 times the width L22 of the microlenses 230 in substantially vertical direction. The substantially vertical width L22 of the microlenses 230 shown in FIG. 19C is a distance between two opposing vertexes.

### EXAMPLES

The lens design and lens pitch setting are performed for the lenticular lens sheet according to each of the above-described embodiments of the present invention

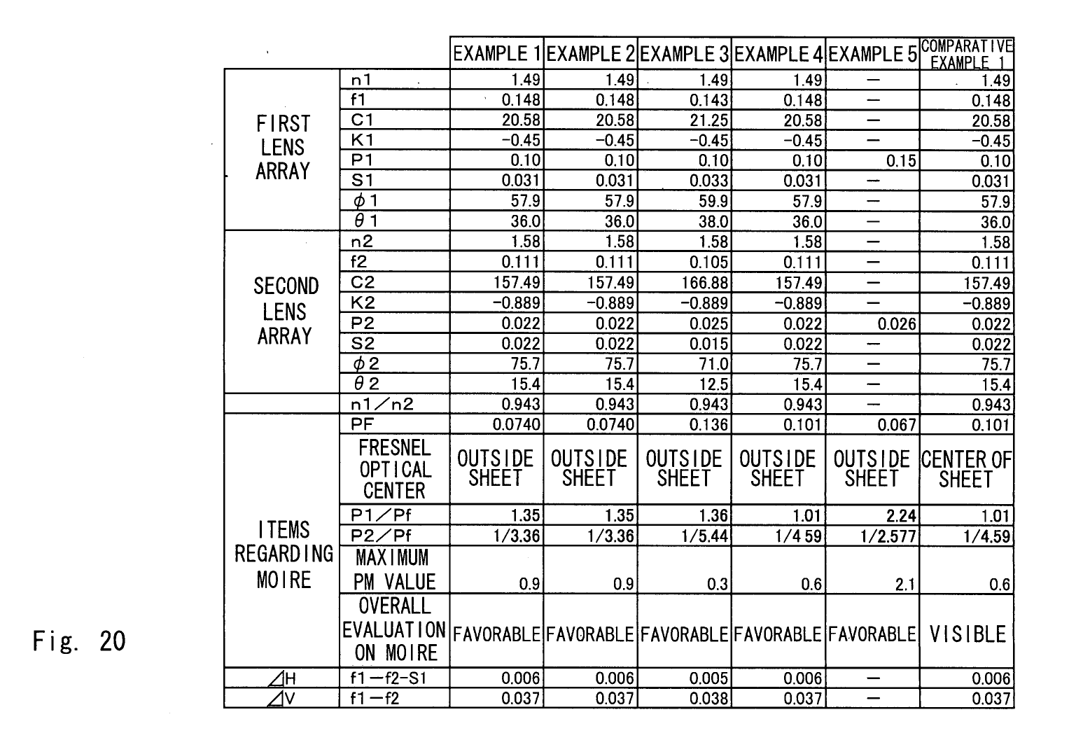

FIG. 20 shows a combination of refractive indexes of lens unit elements, various measurement figures of a lens shape, a pitch-to-pitch ratio of a lens unit, and a moiré period caused by interference among three sets of pitches, related to examples 1 to 5. The examples 1, 2 and 4 correspond to the second embodiment of the present invention, the example 3 to the fourth embodiment, and the example 5 to the fourteenth embodiment.

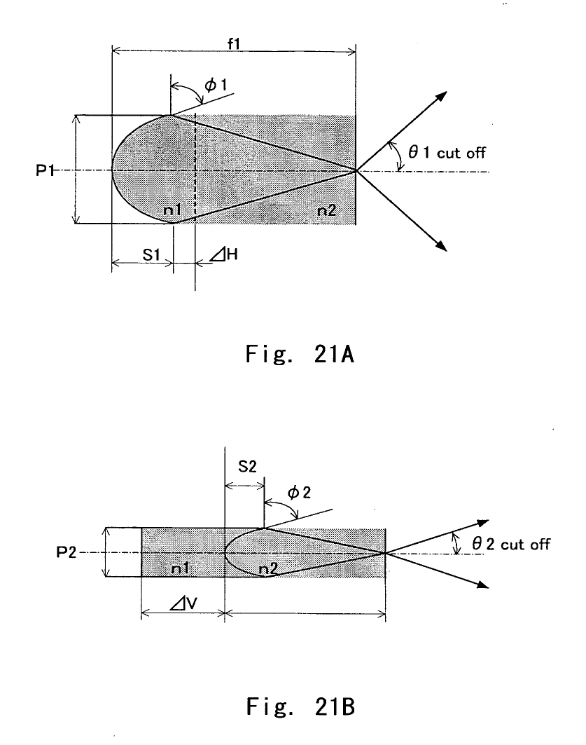

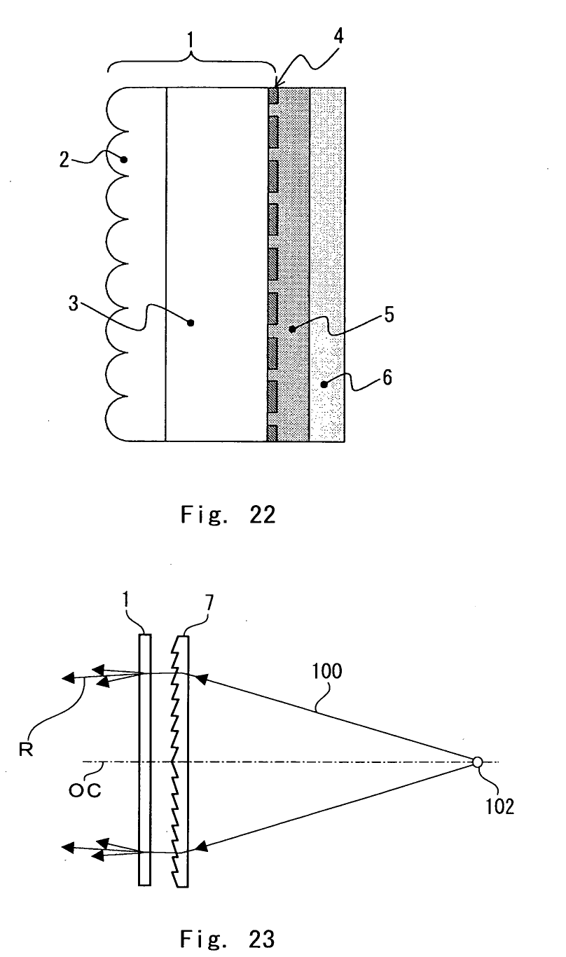

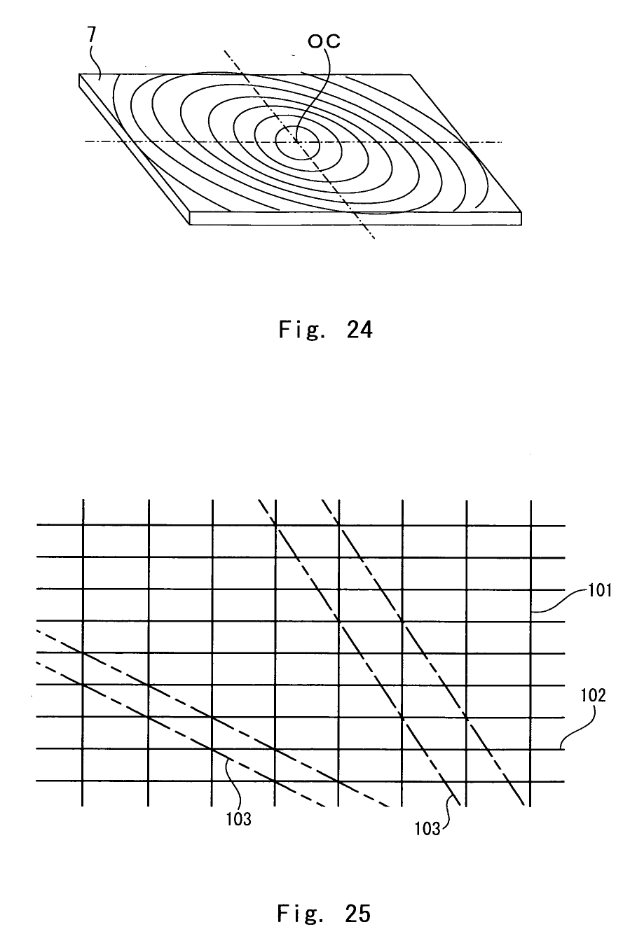

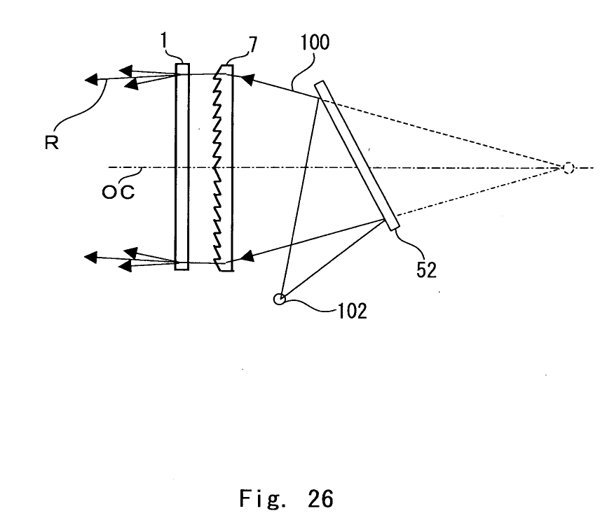

To describe each symbol shown in FIG. 20, FIGS. 21A and 21B show the top sectional view and the cross sectional view, respectively, of the lens unit elements. In FIGS. 20, 21A and 21B, “1” is a numerical subscript indicating the part of the first lens array, “2” is a numerical subscript indicating the part of the second lens array, “n” represents a refractive index of the exit-side material in the lens array, “f1” and “f2” represent the focal lengths [mm] of the first and second lenses for parallel incident light, “C” represents a lens curvature, “K” represents a lens conical constant, “P” represents a lens pitch [mm], and “S” represents a lens depth (SAG) [mm]. In the following equation (8), S represents a maximum depth where a distance X from the lens vertex is X=±P/2.

$$S ( X ) = \frac{{CX}^{2}}{1 + \sqrt{1 - {C}^{2} ( K + 1 ) {X}^{2}}} \qquad ( 8 )$$

Further, “φ” represents a tangential angle [deg] of a lens trough, “θ” represents a lens refractive angle (cutoff angle of output light) [deg], “ΔH” represents a distance [mm] between the trough of the first lens array and the trough of the second lens array, and “ΔV” represents a distance [mm] between the vertex of the first lens array and the vertex of the second lens array.

In the examples 1, 2, 4 and the comparative example 1, the first lens layer is formed of an acrylic ultraviolet curable resin, and the second lens layer is formed of a MS resin.

In the example 3, the first lens layer is formed of a MS resin, the second lens layer is formed of a MS ultraviolet curable resin, and the packed layer 16 is formed of an acrylic ultraviolet curable resin.

Although a visible moiré pattern is observed in the comparative example 1, no moiré pattern is observed in the examples 1, 2, 3, 4 and 5.

### INDUSTRIAL APPLICABILITY

The present invention may be applied to a rear projection-type projection device such as a rear projection-type liquid crystal projection television.

1. A rear projection-type screen comprising:
a Fresnel lens sheet for narrowing light emitted from a rear projection-type projector to a certain range of angle; and
a light diffusion sheet including a plurality of at least substantially vertically and linearly successive optical patterns arranged in substantially horizontal direction,
wherein an optical center of the Fresnel lens sheet is located outside a display screen area, above or below the screen, and
any one of following equations (1) to (3) is satisfied:
$$\begin{matrix}\frac{P 1}{Pf} = i + 0.0 \sim 0.35 or \frac{P 1}{Pf} = \frac{1}{i + 0.0 \sim 0.35} & ( 1 ) \\ \frac{P 1}{Pf} = i + 0.45 \sim 0.55 or \frac{P 1}{Pf} = \frac{1}{i + 0.45 \sim 0.55} & ( 2 ) \\ \frac{P 1}{Pf} = i + 0.65 \sim 1.0 or \frac{P 1}{Pf} = \frac{1}{i + 0.65 \sim 1.0} & ( 3 )\end{matrix}$$
where i represents a natural number of 12 or less, Pf(mm) represents a pitch of the Fresnel lens, and P1(mm) represents a pitch of the optical patterns of the light diffusion sheet.

2. The rear projection-type screen according to claim 1, further comprising, when the substantially vertically and linearly successive optical patterns constitute a first optical pattern array;
a second optical pattern array substantially perpendicular to the first optical pattern array, placed on a light exit side of the first optical pattern array.

3. The rear projection-type screen according to claim 2, wherein the light diffusion sheet includes:
the first optical pattern array having a cylindrical lens shape placed on a light incident surface of the light diffusion sheet,
the second optical pattern array serving as an interface between a light incident side and a light exit side that are formed of light transmissive materials having different refractive indexes from each other, and
a self-aligned external light absorbing layer placed on at least part of a non-transmission portion of light transmitted through the first optical pattern array and the second optical pattern array, such that the light transmissive materials are filled between the light incident surface of the light diffusion sheet and the self-aligned external light absorption layer.

4. The rear projection-type screen according to one of claim 2, wherein the Fresnel lens sheet and the light diffusion sheet satisfy either one of following equations (4) and (5) and further satisfy a following equation (6):
$$\begin{matrix}\frac{P 2}{Pf} = i + 0.35 \sim 0.45 or \frac{P 2}{Pf} = \frac{1}{i + 0.35 \sim 0.45} & ( 4 ) \\ \frac{P 2}{Pf} = i + 0.55 \sim 0.65 or \frac{P 2}{Pf} = \frac{1}{i + 0.55 \sim 0.65} & ( 5 ) \\ PM = \frac{1}{\vert \frac{1}{P} - \frac{1}{Pf} \vert} \leq 3 ( mm ) & ( 6 )\end{matrix}$$
where i represents a natural number of 12 or smaller, a pitch of the first optical patterns is P1 (mm) a pitch of the second optical patterns is P2 (mm), a pitch of a lattice pattern by P1 and P2 along a screen diagonal direction is P (mm) that is calculated from a following equation (7), a pitch of a moiré pattern due to P and Pf is PM (mm), and n and m represent natural numbers of 4 or smaller:
$$P = \frac{1}{\sqrt{\frac{1}{{n}^{2} P {1}^{2}} + \frac{1}{{m}^{2} P {2}^{2}}}} . \qquad ( 7 )$$

5. A rear projection-type screen comprising:
a Fresnel lens sheet for narrowing light emitted from a rear projection-type projector to a certain range of angle; and
a microlens array sheet including a microlens array placed on a light incident surface to diffuse light in substantially horizontal and vertical directions, and a self-aligned external light absorbing layer placed on at least part of a non-transmission portion of light transmitted through the microlens array,
wherein an optical center of the Fresnel lens sheet is located outside a display screen area, above or below the screen,
the Fresnel lens sheet and the microlens array sheet satisfy any one of following equations (1*) to (3*), and
the Fresnel lens sheet and the microlens array sheet satisfy either one of following equations (4*) and (5*) and further satisfy a following equation (6*):
$$\begin{matrix}\frac{P {1}^{*}}{Pf} = i + 0.0 \sim 0.35 or \frac{P {1}^{*}}{Pf} = \frac{1}{i + 0.0 \sim 0.35} & ( {1}^{*} ) \\ \frac{P {1}^{*}}{Pf} = i + 0.45` \sim 0.55 or \frac{P {1}^{*}}{Pf} = \frac{1}{i + 0.45 \sim 0.55} & ( {2}^{*} ) \\ \frac{P {1}^{*}}{Pf} = i + 0.65 \sim 1.0 or \frac{P {1}^{*}}{Pf} = \frac{1}{i + 0.65 \sim 1.0} & ( {3}^{*} )\end{matrix}$$
where i represents a natural number of 12 or smaller, Pf(mm) represents a pitch of the Fresnel lens, and P1*(nm) represents an effective pitch of the microlens array in substantially horizontal direction,
$$\begin{matrix}\frac{P {2}^{*}}{Pf} = i + 0.35 \sim 0.45 or \frac{P {2}^{*}}{Pf} = \frac{1}{i + 0.35 \sim 0.45} & ( {4}^{*} ) \\ \frac{P {2}^{*}}{Pf} = i + 0.55 \sim 0.65 or \frac{P {2}^{*}}{Pf} = \frac{1}{i + 0.55 \sim 0.65} & ( {5}^{*} ) \\ {PM}^{*} = \frac{1}{\vert \frac{1}{{P}^{*}} - \frac{1}{Pf} \vert} \leq 3 ( mm ) & ( {6}^{*} )\end{matrix}$$
where i represents a natural number of 12 or smaller, an effective pitch of a microlens array in substantially vertical direction is P2*(mm), a pitch of a lattice by P1* and P2* in a screen diagonal direction is P*(mm) that is calculated from a following equation (7*), a pitch of a moiré pattern due to P* and Pf is PM*(mm), and n and m represent natural numbers or 4 or smaller,
$${P}^{*} = \frac{1}{\sqrt{\frac{1}{{n}^{2} P {1}^{{*}^{2}}} + \frac{1}{{m}^{2} P {2}^{{*}^{2}}}}} . \qquad ( {7}^{*} )$$

6. The rear projection-type screen according to claim 1, wherein the Fresnel lens sheet has a circular-arc prism array on the light incident surface, at least part of the prism array having a total reflection plane such that at least part of light incident on the prism array is totally reflected by the total reflection plane and exits through a light exit plane.

7. The rear projection-type screen according to claim 3, wherein
the second optical pattern array of the light diffusion sheet is composed of a plurality of cylindrical lenses that are convex toward the light incident side, and
a light transmissive material on a light exit side from an interface of the second optical patter array has a higher refractive index than a light transmissive material on a light incident side.

8. The rear projection-type screen according to claim 3, wherein
the second optical pattern array of the light diffusion sheet is composed of a plurality of cylindrical lenses that are concave toward the light incident side, and
a light transmissive material on a light exit side from an interface of the second optical pattern array has a lower refractive index than a light transmissive material on a light incident side.

9. A rear projection-type projection device comprising a rear projection-type screen according to claim 1.

10. The rear projection-type screen according to claim 7, wherein the Fresnel lens sheet has a circular-arc prism array on the light incident surface, at least of the prism array having a total reflection plane such that at least part of light incident on the prism array is totally reflected by the total reflection plane and exits through a light exit plane.

11. The rear projection-type screen according to claim 3, wherein the Fresnel lens sheet has a circular-arc prism array on the light incident surface, at east part of the prism array having a total reflection plane such that at least part of light incident on the prism array is totally reflected by the total reflection plane and exits through a light exit plane.

12. The rear projection-type screen according to claim 4, wherein the Fresnel lens sheet has a circular-arc prism array on the light incident surface, at least part of the prism array having a total reflection plane such that at least part of light incident on the prism array is totally reflected by the total reflection plane and exits through a light exit plane.

13. A rear projection-type projection device comprising a rear projection-type screen according to claim 2.

14. A rear projection-type projection device comprising a rear projection-type screen according to claim 3.

15. A rear projection-type projection device comprising a rear projection-type screen according to claim 4.

16. A rear projection-type projection device comprising a rear projection-type screen according to claim 5.
